(19) United States
(12) Patent Application Publication
(10) Pub. No.: US 2026/0313419 A1
(43) Pub. Date: Oct. 8, 2026

(54) MEASUREMENT RESOURCE CONFIGURATION AND REPORTING

(71) Applicant: QUALCOMM Incorporated, San Diego, CA (US)

(72) Inventors: Qian ZHANG, Basking Ridge, NJ (US); Junyi LI, Greentown, PA (US); Jae Ho RYU, San Diego, CA (US)

(21) Appl. No.: 19/170,426

(22) Filed: Apr. 4, 2025

(51) Int. Cl. H04W 24/10; H04B 7/06; H04B 17/318

(52) U.S. Cl. CPC H04W 24/10; H04B 7/06968; H04B 17/328

(57) ABSTRACT

Various aspects of the present disclosure generally relate to wireless communication. In some aspects, a network node may configure a UE to measure layer 1 (L1) cross-link interference (CLI) measurement resources, and a UE may transmit a measurement report for a quantity of L1 CLI measurement resources that indicates that at least one measurement result in an out-of-range. In some aspects, the measurement report may indicate that a first measurement result (for example, an absolute measurement result for a most interfered measurement resource) is out-of-range by indicating a first codepoint that maps to a largest value of a measurement range in an L1 CLI absolute codebook, or that a second measurement result (for example, a differential measurement result for a second most interfered measurement resource) is out-of-range by indicating a second codepoint that maps to an out-of-range value in an L1 CLI differential codebook. Numerous other aspects are described.

### FIELD OF THE DISCLOSURE

Aspects of the present disclosure generally relate to wireless communication and specifically relate to techniques, apparatuses, and methods associated with measurement resource configuration and reporting.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, wireless communication devices may be capable of full duplex communication, such as sub-band full duplex (SBFD) communication. SBFD communication relates to simultaneous transmission and reception of communications on a sub-band basis. In SBFD, a network node may receive, from a first user equipment (UE), an uplink communication and may transmit, to a second UE, a downlink communication at the same time, but on different frequency resources. In some examples, SBFD communication may result in inter-UE cross-link interference (CLI). For example, a UE transmitting an uplink communication using one sub-band (SB) in a cell may cause inter-UE CLI to a UE receiving a downlink transmission in the same cell using another SB, which is sometimes referred to herein as inter-SB, intra-cell, inter-UE CLI. Similarly, a UE transmitting an uplink communication using one SB in one cell may cause inter-UE CLI to a UE receiving a downlink transmission using another SB in another cell, which is sometimes referred to herein as inter-SB, inter-cell, inter-UE CLI.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving configuration information configuring a first quantity of layer 1 (L1) cross-link interference (CLI) measurement resources. The method may include transmitting a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to a method of wireless communication performed by a UE. The method may include receiving configuration information configuring a first quantity of L1 CLI measurement resources. The method may include transmitting a measurement report for a second quantity of the L1 CLI measurement resources that indicates: a first measurement result for a first CLI measurement resource, of the second quantity of CLI measurement resources; a second measurement result for a second CLI measurement resource, of the second quantity of CLI measurement resources, by indicating a first difference between the first measurement result and the second measurement result; and a third measurement result for a third CLI measurement resource, of the second quantity of CLI measurement resources, by indicating a second difference between the second measurement result and the third measurement result.

Some aspects described herein relate to a method of wireless communication performed by a UE. The method may include receiving configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The method may include transmitting the measurement report in accordance with the configuration information.

Some aspects described herein relate to a method of wireless communication performed by a UE. The method may include receiving configuration information configuring a periodic CLI measurement resource and a first quasi co-location (QCL) assumption for type D for the periodic CLI measurement resource. The method may include receiving a medium access control (MAC) control element (MAC-CE) updating the first QCL assumption to a second QCL assumption. The method may include measuring the periodic CLI measurement resource in accordance with the second QCL assumption. The method may include transmitting a measurement report in accordance with the configuration information and the second QCL assumption.

Some aspects described herein relate to a method of wireless communication performed by a network node. The method may include transmitting, to a UE, configuration information configuring a first quantity of L1 CLI measurement resources. The method may include receiving, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to a method of wireless communication performed by a network node. The method may include transmitting, to a UE, configuration information configuring a first quantity of L1 CLI measurement resources. The method may include receiving, from the UE, a measurement report for a second quantity of the L1 CLI measurement resources that indicates: a first measurement result for a first CLI measurement resource, of the second quantity of CLI measurement resources; a second measurement result for a second CLI measurement resource, of the second quantity of CLI measurement resources, by indicating a first difference between the first measurement result and the second measurement result; and a third measurement result for a third CLI measurement resource, of the second quantity of CLI measurement resources, by indicating a second difference between the second measurement result and the third measurement result.

Some aspects described herein relate to a method of wireless communication performed by a network node. The method may include transmitting, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The method may include receiving, from the UE, the measurement report in accordance with the configuration information.

Some aspects described herein relate to a method of wireless communication performed by a network node. The method may include transmitting, to a UE, configuration information configuring a periodic CLI measurement resource and a first QCL assumption for type D for the periodic CLI measurement resource. The method may include transmitting, to the UE, a MAC-CE updating the first QCL assumption to a second QCL assumption. The method may include receiving, from the UE, a measurement report in accordance with the configuration information and the second QCL assumption.

Some aspects described herein relate to a UE. The UE may include a processing system. The processing system may include one or more processors and one or more code-storing memories coupled with the one or more processors. The processing system may be configured to cause the UE to receive configuration information configuring a first quantity of L1 CLI measurement resources. The processing system may be configured to cause the UE to transmit a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to a UE. The UE may include a processing system. The processing system may include one or more processors and one or more code-storing memories coupled with the one or more processors. The processing system may be configured to cause the UE to receive configuration information configuring a first quantity of L1 CLI measurement resources. The processing system may be configured to cause the UE to transmit a measurement report for a second quantity of the L1 CLI measurement resources that indicates: a first measurement result for a first CLI measurement resource, of the second quantity of CLI measurement resources; a second measurement result for a second CLI measurement resource, of the second quantity of CLI measurement resources, by indicating a first difference between the first measurement result and the second measurement result; and a third measurement result for a third CLI measurement resource, of the second quantity of CLI measurement resources, by indicating a second difference between the second measurement result and the third measurement result.

Some aspects described herein relate to a UE. The UE may include a processing system. The processing system may include one or more processors and one or more code-storing memories coupled with the one or more processors. The processing system may be configured to cause the UE to receive configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The processing system may be configured to cause the UE to transmit the measurement report in accordance with the configuration information.

Some aspects described herein relate to a UE. The UE may include a processing system. The processing system may include one or more processors and one or more code-storing memories coupled with the one or more processors. The processing system may be configured to cause the UE to receive configuration information configuring a periodic CLI measurement resource and a first QCL assumption for type D for the periodic CLI measurement resource. The processing system may be configured to cause the UE to receive a MAC-CE updating the first QCL assumption to a second QCL assumption. The processing system may be configured to cause the UE to measure the periodic CLI measurement resource in accordance with the second QCL assumption. The processing system may be configured to cause the UE to transmit a measurement report in accordance with the configuration information and the second QCL assumption.

Some aspects described herein relate to a network node. The network node may include a processing system. The processing system may include one or more processors and one or more code-storing memories coupled with the one or more processors. The processing system may be configured to cause the network node to transmit, to a UE, configuration information configuring a first quantity of L1 CLI measurement resources. The processing system may be configured to cause the network node to receive, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to a network node. The network node may include a processing system. The processing system may include one or more processors and one or more code-storing memories coupled with the one or more processors. The processing system may be configured to cause the network node to transmit, to a UE, configuration information configuring a first quantity of L1 CLI measurement resources. The processing system may be configured to cause the network node to receive, from the UE, a measurement report for a second quantity of the L1 CLI measurement resources that indicates, a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.

Some aspects described herein relate to a network node. The network node may include a processing system. The processing system may include one or more processors and one or more code-storing memories coupled with the one or more processors. The processing system may be configured to cause the network node to transmit, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The processing system may be configured to cause the network node to receive, from the UE, the measurement report in accordance with the configuration information.

Some aspects described herein relate to a network node. The network node may include a processing system. The processing system may include one or more processors and one or more code-storing memories coupled with the one or more processors. The processing system may be configured to cause the network node to transmit, to a UE, configuration information configuring a periodic CLI measurement resource and a first QCL assumption for type D for the periodic CLI measurement resource. The processing system may be configured to cause the network node to transmit, to the UE, a MAC-CE updating the first QCL assumption to a second QCL assumption. The processing system may be configured to cause the network node to receive, from the UE, a measurement report in accordance with the configuration information and the second QCL assumption.

Some aspects described herein relate to a non-transitory computer-readable medium that stores a set of instructions for wireless communication by a UE. The set of instructions, when executed by one or more processors of the UE, may cause the UE to receive configuration information configuring a first quantity of L1 CLI measurement resources. The set of instructions, when executed by one or more processors of the UE, may cause the UE to transmit a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to a non-transitory computer-readable medium that stores a set of instructions for wireless communication by a UE. The set of instructions, when executed by one or more processors of the UE, may cause the UE to receive configuration information configuring a first quantity of L1 CLI measurement resources. The set of instructions, when executed by one or more processors of UE, may cause the UE to transmit a measurement report for a second quantity of the L1 CLI measurement resources that indicates: a first measurement result for a first CLI measurement resource, of the second quantity of CLI measurement resources; a second measurement result for a second CLI measurement resource, of the second quantity of CLI measurement resources, by indicating a first difference between the first measurement result and the second measurement result; and a third measurement result for a third CLI measurement resource, of the second quantity of CLI measurement resources, by indicating a second difference between the second measurement result and the third measurement result.

Some aspects described herein relate to a non-transitory computer-readable medium that stores a set of instructions for wireless communication by a UE. The set of instructions, when executed by one or more processors of the UE, may cause the UE to receive configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The set of instructions, when executed by one or more processors of the UE, may cause the UE to transmit the measurement report in accordance with the configuration information.

Some aspects described herein relate to a non-transitory computer-readable medium that stores a set of instructions for wireless communication by a UE. The set of instructions, when executed by one or more processors of the UE, may cause the UE to receive configuration information configuring a periodic CLI measurement resource and a first QCL assumption for type D for the periodic CLI measurement resource. The set of instructions, when executed by one or more processors of UE, may cause the UE to receive a MAC-CE updating the first QCL assumption to a second QCL assumption. The set of instructions, when executed by one or more processors of the UE, may cause the UE to measure the periodic CLI measurement resource in accordance with the second QCL assumption. The set of instructions, when executed by one or more processors of the UE, may cause the UE to transmit a measurement report in accordance with the configuration information and the second QCL assumption.

Some aspects described herein relate to a non-transitory computer-readable medium that stores a set of instructions for wireless communication by a network node. The set of instructions, when executed by one or more processors of the network node, may cause the network node to transmit, to a UE, configuration information configuring a first quantity of L1 CLI measurement resources. The set of instructions, when executed by one or more processors of the network node, may cause the network node to receive, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to a non-transitory computer-readable medium that stores a set of instructions for wireless communication by a network node. The set of instructions, when executed by one or more processors of the network node, may cause the network node to transmit, to a UE, configuration information configuring a first quantity of L1 CLI measurement resources. The set of instructions, when executed by one or more processors of the network node, may cause the network node to receive, from the UE, a measurement report for a second quantity of the L1 CLI measurement resources that indicates: a first measurement result for a first CLI measurement resource, of the second quantity of CLI measurement resources; a second measurement result for a second CLI measurement resource, of the second quantity of CLI measurement resources, by indicating a first difference between the first measurement result and the second measurement result; and a third measurement result for a third CLI measurement resource, of the second quantity of CLI measurement resources, by indicating a second difference between the second measurement result and the third measurement result.

Some aspects described herein relate to a non-transitory computer-readable medium that stores a set of instructions for wireless communication by a network node. The set of instructions, when executed by one or more processors of the network node, may cause the network node to transmit, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The set of instructions, when executed by one or more processors of the network node, may cause the network node to receive, from the UE, the measurement report in accordance with the configuration information.

Some aspects described herein relate to a non-transitory computer-readable medium that stores a set of instructions for wireless communication by a network node. The set of instructions, when executed by one or more processors of the network node, may cause the network node to transmit, to a UE, configuration information configuring a periodic CLI measurement resource and a first QCL assumption for type D for the periodic CLI measurement resource. The set of instructions, when executed by one or more processors of the network node, may cause the network node to transmit, to the UE, a MAC-CE updating the first QCL assumption to a second QCL assumption. The set of instructions, when executed by one or more processors of the network node, may cause the network node to receive, from the UE, a measurement report in accordance with the configuration information and the second QCL assumption.

Some aspects described herein relate to an apparatus for wireless communication. The apparatus may include means for receiving configuration information configuring a first quantity of L1 CLI measurement resources. The apparatus may include means for transmitting a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to an apparatus for wireless communication. The apparatus may include means for receiving configuration information configuring a first quantity of L1 CLI measurement resources. The apparatus may include means for transmitting a measurement report for a second quantity of the L1 CLI measurement resources that indicates, a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.

Some aspects described herein relate to an apparatus for wireless communication. The apparatus may include means for receiving configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The apparatus may include means for transmitting the measurement report in accordance with the configuration information.

Some aspects described herein relate to an apparatus for wireless communication. The apparatus may include means for receiving configuration information configuring a periodic CLI measurement resource and a first QCL assumption for type D for the periodic CLI measurement resource. The apparatus may include means for receiving a MAC-CE updating the first QCL assumption to a second QCL assumption. The apparatus may include means for measuring the periodic CLI measurement resource in accordance with the second QCL assumption. The apparatus may include means for transmitting a measurement report in accordance with the configuration information and the second QCL assumption.

Some aspects described herein relate to an apparatus for wireless communication. The apparatus may include means for transmitting, to a UE, configuration information configuring a first quantity of L1 CLI measurement resources. The apparatus may include means for receiving, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

Some aspects described herein relate to an apparatus for wireless communication. The apparatus may include means for transmitting, to a UE, configuration information configuring a first quantity of L1 CLI measurement resources. The apparatus may include means for receiving, from the UE, a measurement report for a second quantity of the L1 CLI measurement resources that indicates, a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.

Some aspects described herein relate to an apparatus for wireless communication. The apparatus may include means for transmitting, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The apparatus may include means for receiving, from the UE, the measurement report in accordance with the configuration information.

Some aspects described herein relate to an apparatus for wireless communication. The apparatus may include means for transmitting, to a UE, configuration information configuring a periodic CLI measurement resource and a first QCL assumption for type D for the periodic CLI measurement resource. The apparatus may include means for transmitting, to the UE, a MAC-CE updating the first QCL assumption to a second QCL assumption. The apparatus may include means for receiving, from the UE, a measurement report in accordance with the configuration information and the second QCL assumption.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIGS. 2A-2C are diagrams illustrating examples of full duplex (FD) communication.

FIG. 3 is a diagram illustrating examples of FD communication in a wireless network.

FIG. 4 is a diagram illustrating an example of cross-link interference (CLI) associated with sub-band FD (SBFD) communications.

FIG. 5 is a diagram illustrating an example of CLI associated with partially or fully overlapped FD communications.

FIGS. 6A-6C are diagrams of examples associated with CLI measurement and reporting.

FIG. 7 is a flowchart illustrating an example process performed, for example, at a UE or an apparatus of a UE that supports measurement resource configuration and reporting.

FIG. 8 is another flowchart illustrating an example process performed, for example, at a UE or an apparatus of a UE that supports measurement resource configuration and reporting.

FIG. 9 is another flowchart illustrating an example process performed, for example, at a UE or an apparatus of a UE that supports measurement resource configuration and reporting.

FIG. 10 is another flowchart illustrating an example process performed, for example, at a UE or an apparatus of a UE that supports measurement resource configuration and reporting.

FIG. 11 is a flowchart illustrating an example process performed, for example, at a network node or an apparatus of a network node that supports measurement resource configuration and reporting.

FIG. 12 is another flowchart illustrating an example process performed, for example, at a network node or an apparatus of a network node that supports measurement resource configuration and reporting.

FIG. 13 is another flowchart illustrating an example process performed, for example, at a network node or an apparatus of a network node that supports measurement resource configuration and reporting.

FIG. 14 is another flowchart illustrating an example process performed, for example, at a network node or an apparatus of a network node that supports measurement resource configuration and reporting.

FIG. 15 is a diagram of an example apparatus for wireless communication that supports measurement resource configuration and reporting.

FIG. 16 is another diagram of an example apparatus for wireless communication that supports measurement resource configuration and reporting.

FIG. 17 is another diagram of an example apparatus for wireless communication that supports measurement resource configuration and reporting.

FIG. 18 is another diagram of an example apparatus for wireless communication that supports measurement resource configuration and reporting.

FIG. 19 is another diagram of an example apparatus for wireless communication that supports measurement resource configuration and reporting.

FIG. 20 is another diagram of an example apparatus for wireless communication that supports measurement resource configuration and reporting.

FIG. 21 is another diagram of an example apparatus for wireless communication that supports measurement resource configuration and reporting.

FIG. 22 is another diagram of an example apparatus for wireless communication that supports measurement resource configuration and reporting.

### DETAILED DESCRIPTION

In wireless communication systems, wireless communication devices (for example, network nodes and user equipments (UEs), among other examples) may be capable of full duplex communication, such as sub-band full duplex (SBFD) communication, among other examples. “Full-duplex communication” in a wireless network refers to simultaneous bi-directional communication between devices in the wireless network. For example, a UE operating in a full-duplex mode may transmit an uplink communication and receive a downlink communication at the same time (for example, in the same slot or the same symbol). Similarly, a network node operating in a full-duplex mode may transmit a downlink communication and receive an uplink communication at the same time (for example, in the same slot or the same symbol). In SBFD communication, a network node may simultaneously transmit and receive downlink communications and uplink communications, respectively, on a sub-band (SB) basis.

In some examples, full-duplex operation may result in cross-link interference (CLI) among various wireless communication devices. For example, in an SBFD scenario, a network node associated with a first cell may receive an uplink transmission from a first UE, such as by using an uplink SB of an SBFD set of symbols, and the network node may transmit a downlink transmission to a second UE in the first cell, such as by using a downlink SB of the SBFD set of symbols. In such cases, the first UE may cause an inter-SB, intra-cell, inter-UE CLI to the second UE based at least in part on the uplink transmission of the first UE. Similarly, the uplink transmission of the first UE in the first cell may cause an inter-SB, inter-cell, inter-UE CLI to a third UE operating in a second cell (for example, a neighboring cell), such as a UE receiving a downlink transmission using a downlink SB in the neighboring cell.

Accordingly, a network node may configure a UE to measure and report CLI, such as the inter-UE CLI described above. More particularly, the network node may configure the UE with one or more resources for performing CLI measurements, such as layer 1 (L1) CLI measurements, among other examples, or one or more resources for transmitting one or more measurement reports, such as one or more L1 measurement reports, among other examples. Such measurement and reporting procedures may result in relatively high resource consumption associated with the various measurements and reports. For example, reporting absolute measurement values for each configured inter-UE CLI measurement resource may require numerous bits per reported measurement result, resulting in high computing, power, and network resource consumption. Accordingly, in order to reduce overhead associated with such reporting, a network node may configure a UE to report CLI relatively infrequently or for only a few measurement resources.

Moreover, in some examples a UE may be configured with a measurement range in which to report CLI measurements. However, if a reported CLI measurement result falls outside that range (for example, if a reported CLI measurement result is larger than a largest value in the measurement range), the UE may not be capable of indicating the measurement result to the network node. By exchanging infrequent measurement reports or by using measurement reports containing inaccurate data, traditional measurement resource configuration and reporting techniques may result in reduced information exchange between the network node and the UE and thus suboptimal network configurations, increased communication errors, and high power, computing, and network resource consumption for correcting communication errors.

Various aspects relate generally to improved measurement and reporting procedures. Some aspects more specifically relate to improved CLI (for example, inter-UE CLI) measurement and reporting procedures. In some aspects, a network node may configure a UE to measure L1 CLI measurement resources, and a UE may transmit a measurement report for a quantity of L1 CLI measurement resources that indicates that at least one measurement result is out-of-range. For example, the measurement report may indicate that a first measurement result (for example, an absolute measurement result for a most interfered measurement resource) is larger than a largest value of the measurement range by indicating a codepoint that maps to a largest value of a measurement range in an L1 CLI absolute codebook. Similarly, the measurement report may indicate that one or more additional measurement results are out-of-range, such as by indicating that a second measurement result (for example, a differential measurement result for a second most interfered measurement resource) is larger than a largest value of the measurement range by indicating a codepoint that maps to an out-of-range value in an L1 CLI differential codebook.

In some other aspects, the measurement report may indicate measurement results using an improved differential reporting method. In such aspects, the measurement report may indicate a first measurement result (for example, a measurement result for a most interfered measurement resource), such as by indicating an absolute value of the first measurement result. The measurement report may further indicate a second measurement result (for example, a measurement result for a second most interfered measurement resource) by indicating a first difference between the first measurement result and the second measurement result. Similarly, the measurement report may further indicate a third measurement result (for example, a measurement result for a third most interfered measurement resource) by indicating a second difference between the second measurement result and the third measurement result, and so forth for the remaining measurement results.

In some other aspects, the network node may configure the UE with certain parameters used to report measurement results in a measurement report. For example, the network node may transmit, to the UE, configuration information configuring at least one of a quantity of bits for a codepoint used to report measurement results in a measurement report (for example, a codepoint used to report an absolute measurement result or a differential measurement result), a measurement range used to report the measurement results in the measurement report (for example, a measurement range associated with an absolute codebook or a differential codebook), a codebook resolution used to report the measurement results in the measurement report (for example, a step size for the absolute codebook or the differential codebook), or one or more events that trigger the measurement report.

In some other aspects, the network node may update one or more parameters associated with a measurement report using a MAC-CE. More particularly, the network node may transmit, to the UE, configuration information configuring a periodic measurement resource having first quasi co-location (QCL) assumption for type D. If the network node thereafter needs to update the QCL assumption, the network node may transmit a MAC-CE updating the first QCL assumption to a second QCL assumption. The UE may thus measure the periodic CLI measurement resource in accordance with the second QCL assumption, and may transmit a measurement report in accordance with the configuration information and the second QCL assumption.

Particular aspects of the subject matter described in this disclosure can be implemented to realize one or more of the following potential advantages. In some examples, the described techniques can be used by to improve information exchange between a UE and a network node, such as by enabling reporting of out-of-range measurements to the network node. This increased information exchange between the wireless communication devices may result in optimized network configurations and thus reduced communication errors, resulting in reduced power, computing, and network resource consumption otherwise required for correcting communication errors.

Additionally or alternatively, the described techniques enable an improved differential reporting procedure (for example, a procedure where a second most interfered measurement result is reported as a differential value with respect to the most interfered measurement result, a third most interfered measurement result is reported as a differential value with respect to the second most interfered measurement result, and so forth). The improved differential reporting procedure may result in reduced signaling overhead because a difference between the corresponding measurement results may be relatively small and thus a smaller measurement range may be used in a differential codebook with less bits needed to indicate each codepoint (for example, two or three bits may be used to report a differential measurement result rather than four bits used in some traditional reporting mechanisms). In this way, the aspects described herein may enable more frequent measurement reports or reporting measurement results for a greater quantity of measurement resources, which may result in increased information exchange between the network node and the UE and thus optimized network configuration settings, decreased communication errors, and reduced power, computing, and network resource consumption otherwise required for correcting communication errors.

Additionally or alternatively, the described techniques enable flexible configuration of various parameters for reporting measurement results, such as the quantity of bits for a codepoint used to report measurement results in a measurement report, the measurement range used to report the measurement results in the measurement report, the codebook resolution used to report the measurement results in the measurement report, or the one or more events that trigger the measurement report described above. This flexible configuration may result in reduced signaling overhead (for example, in aspects in which the configured parameters require less bits than default parameters), resulting in reduced latency, increased throughout, and overall more efficient usage of network resources. Moreover, the flexibility in configuring reporting parameters, such as the range and resolution, tailored to specific scenarios or UE capabilities, can lead to reduced signaling overhead and increased efficiency by enabling the network node to better manage interference and optimize resource utilization based on real-time conditions, which can conserve network resources by minimizing unnecessary signaling and effectively managing radio resource allocation.

Additionally or alternatively, the described techniques enable quick and efficient updating of QCL assumptions associated with periodic measurement resources, such by enabling transmission of the MAC-CE updating a QCL assumption. As a result, the network node may update QCL assumptions with reduced latency, thereby resulting in more efficient communications and usage of wireless communication resources. Moreover, by using a MAC-CE

to update QCL assumptions for periodic measurement resources, the UE and the network node may forgo radio resource control (RRC) reconfiguration procedures otherwise required to update QCL assumptions, thereby decreasing latency, reducing signaling overhead, and conserving network resources by avoiding frequent RRC reconfigurations. 5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

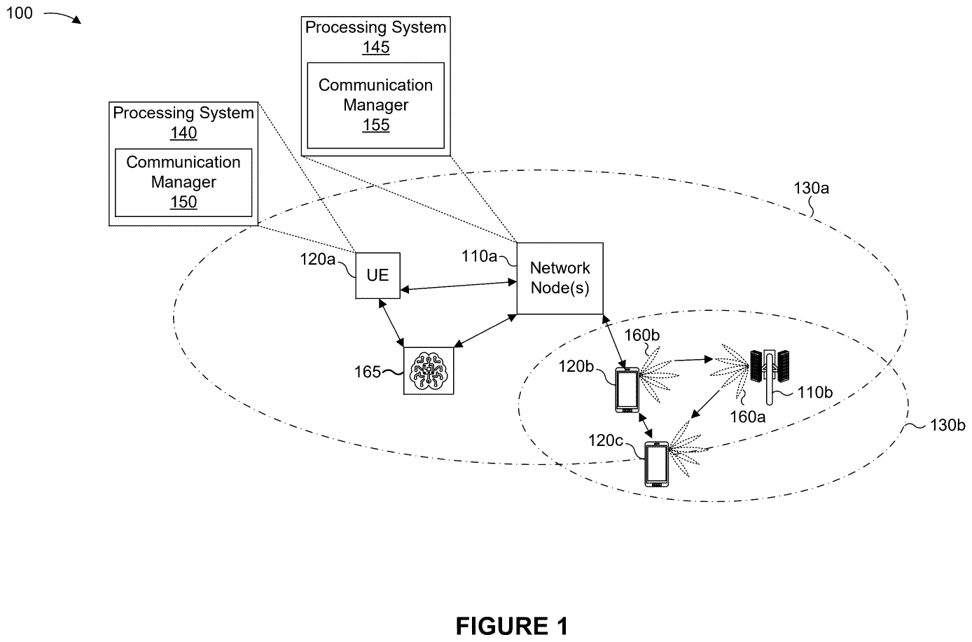

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN),

to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a MAC layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, an L1-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a QCL parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve frequency division duplexing (FDD), in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may receive configuration information configuring a first quantity of L1 CLI measurement resources; and transmit a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range. In some other aspects, the communication manager 150 may receive configuration information configuring a first quantity of L1 CLI measurement resources; and transmit a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result. In some other aspects, the communication manager 150 may receive configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report; and transmit the measurement report in accordance with the configuration information. Additionally or alternatively, the communication manager 150 may perform one or more other operations described herein. In some other aspects, the communication manager 150 may receive configuration information configuring a periodic CLI measurement resource and a first QCL assumption for type D for the periodic CLI measurement resource; receive a MAC-CE updating the first QCL assumption to a second QCL assumption; measure the periodic CLI measurement resource in accordance with the second QCL assumption; and transmit a measurement report in accordance with the configuration information and the second QCL assumption. Additionally or alternatively, the communication manager 150 may perform one or more other operations described herein.

In some aspects, the network node 110 may include a communication manager 155. As described in more detail elsewhere herein, the communication manager 155 may transmit, to a UE, configuration information configuring a first quantity of L1 CLI measurement resources; and receive, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range. In some other aspects, the communication manager 155 may transmit, to a UE, configuration information configuring a first quantity of L1 CLI measurement resources; and receive, from the UE, a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result. In some other aspects, the communication manager 155 may transmit, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report; and receive, from the UE, the measurement report in accordance with the configuration information. In some other aspects, the communication manager 155 may transmit, to a UE, configuration information configuring a periodic CLI measurement resource and a first QCL assumption for type D for the periodic CLI measurement resource; transmit, to the UE, a MAC-CE updating the first QCL assumption to a second QCL assumption; and receive, from the UE, a measurement report in accordance with the configuration information and the second QCL assumption. Additionally or alternatively, the communication manager 155 may perform one or more other operations described herein.

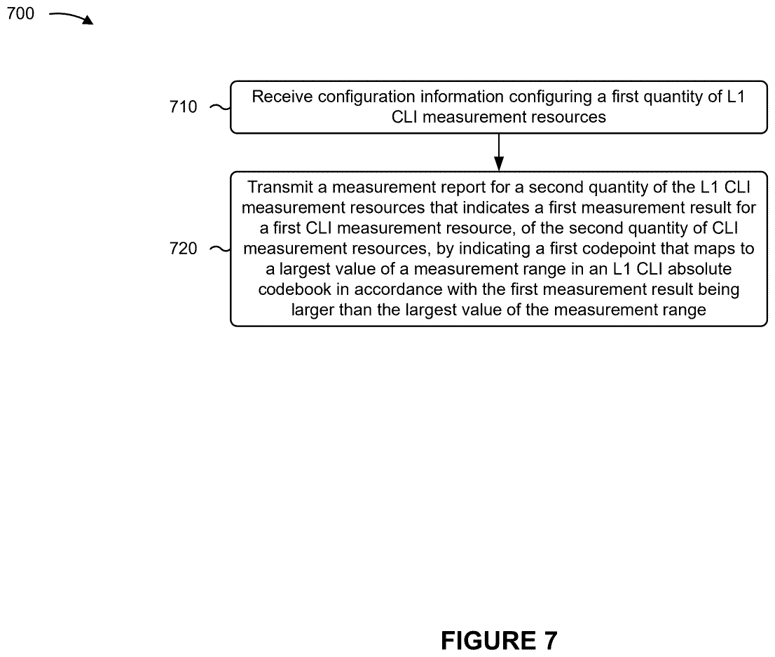

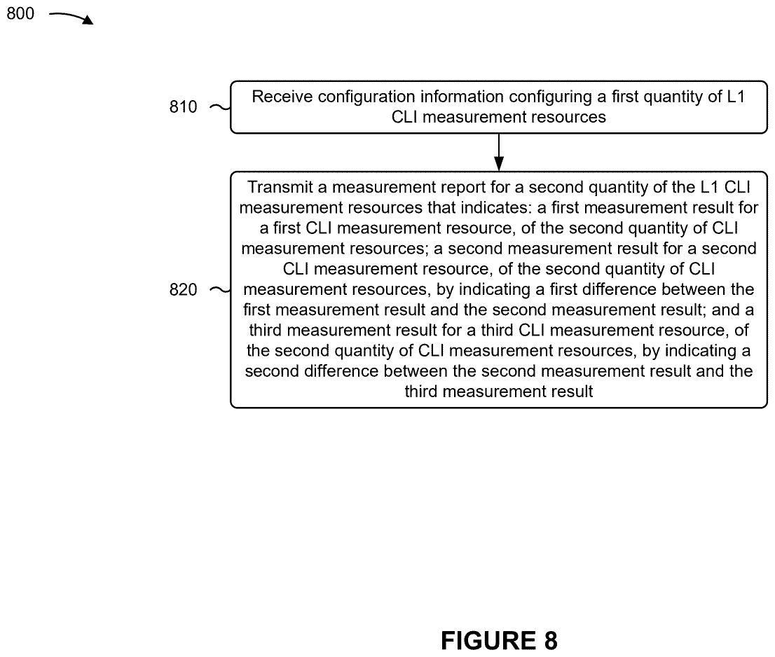

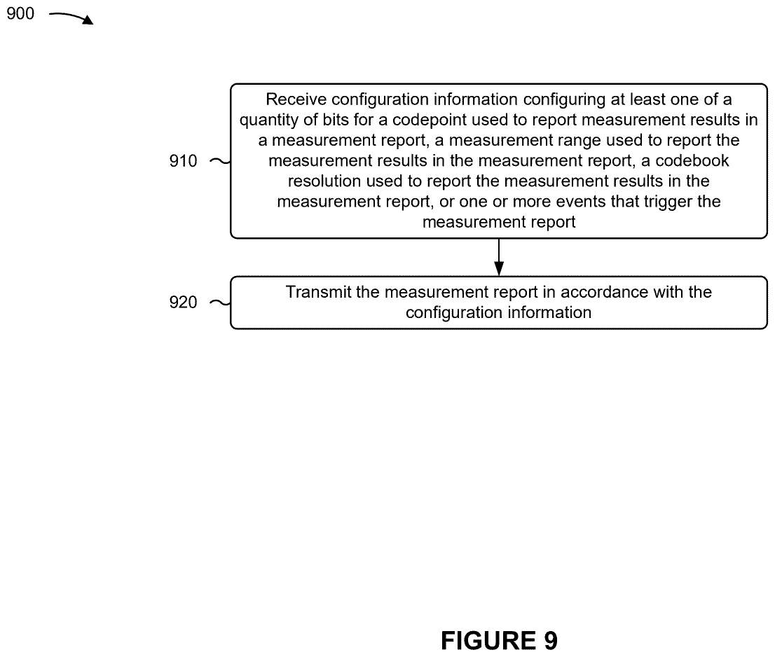

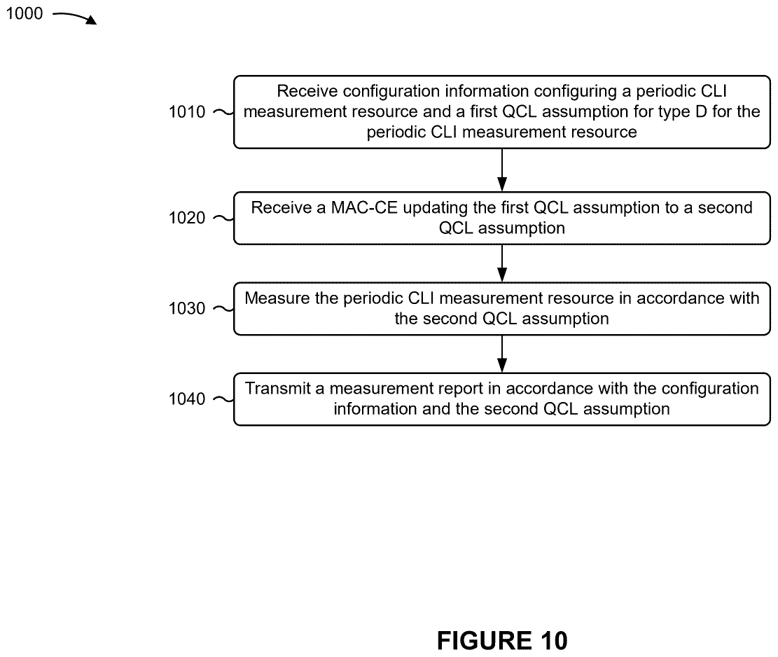

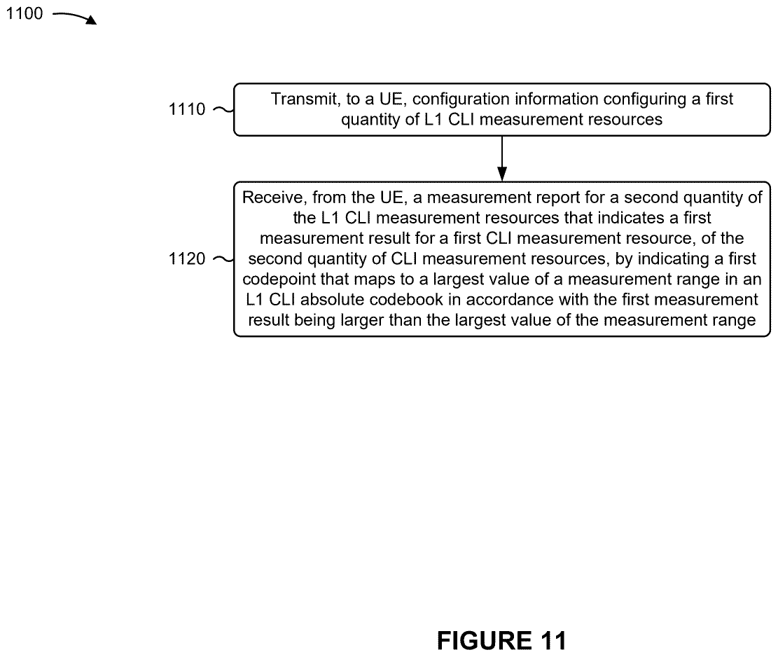

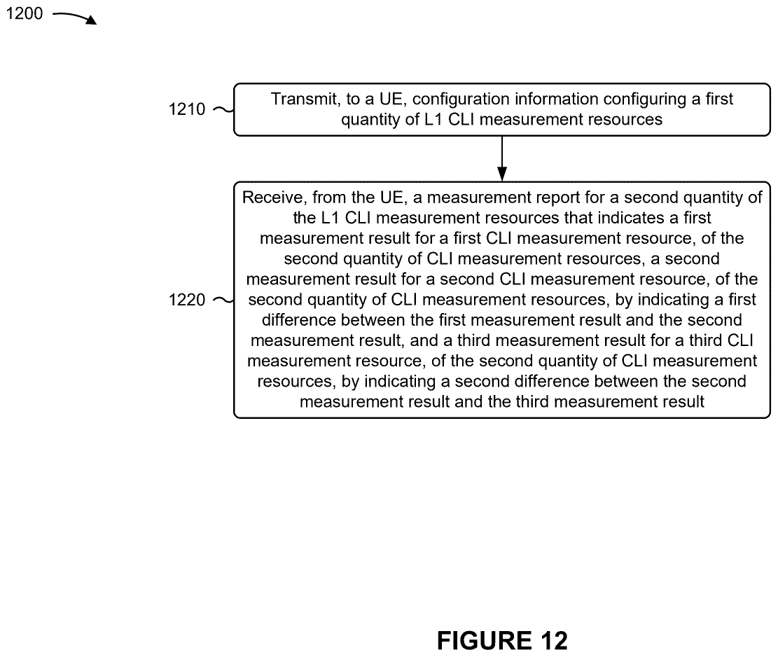

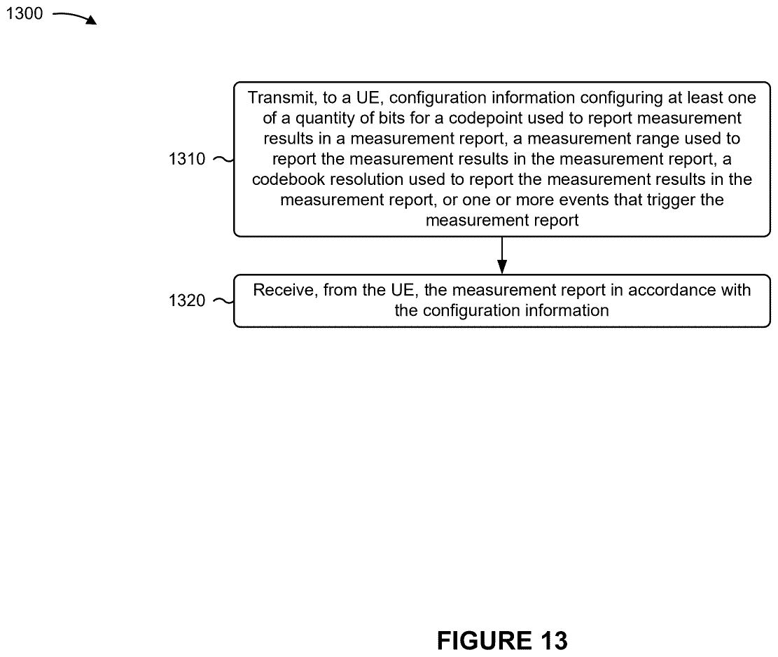

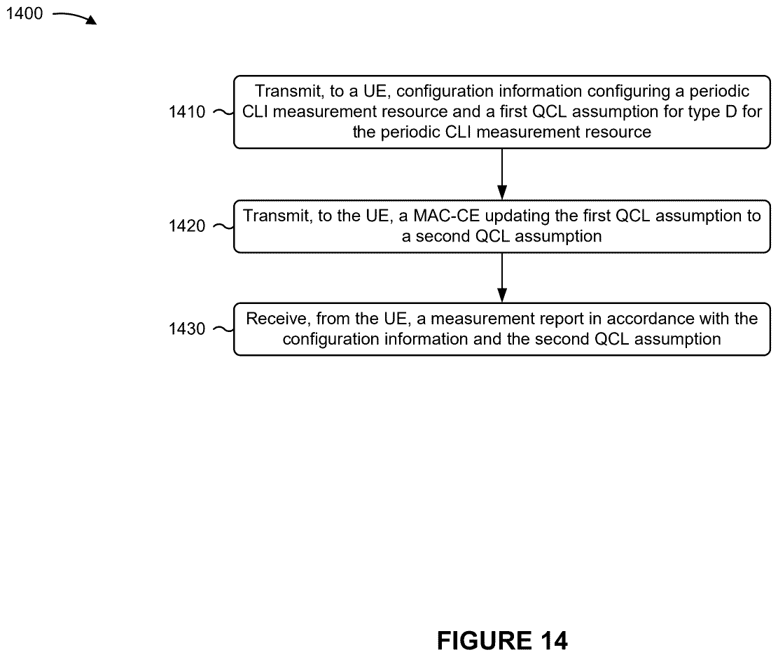

The network node 110, the processing system 145 of the network node 110, the UE 120, the processing system 140 of the UE 120, or any other component(s) of FIG. 1 may implement one or more techniques or perform one or more operations associated with measurement resource configuration and reporting, as described in more detail elsewhere herein. For example, the processing system 145 of the network node 110, or the processing system 140 of the UE 120, may perform or direct operations of, for example, process 700 of FIG. 7, process 800 of FIG. 8, process 900 of FIG. 9, process 1000 of FIG. 10, process 1100 of FIG. 11, process 1200 of FIG. 12, process 1300 of FIG. 13, process 1400 of FIG. 14, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, process 900 of FIG. 9, process 1000 of FIG. 10, process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

In some aspects, the UE 120 includes means for receiving configuration information configuring a first quantity of L1 CLI measurement resources; or means for transmitting a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range. In some other aspects, the UE 120 includes means for receiving configuration information configuring a first quantity of L1 CLI measurement resources; or means for transmitting a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.

In some other aspects, the UE 120 includes means for receiving configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report; or means for transmitting the measurement report in accordance with the configuration information. In some other aspects, the UE 120 includes means for receiving configuration information configuring a periodic CLI measurement resource and a first QCL assumption for type D for the periodic CLI measurement resource; means for receiving a MAC-CE updating the first QCL assumption to a second QCL assumption; means for measuring the periodic CLI measurement resource in accordance with the second QCL assumption; or means for transmitting a measurement report in accordance with the configuration information and the second QCL assumption.

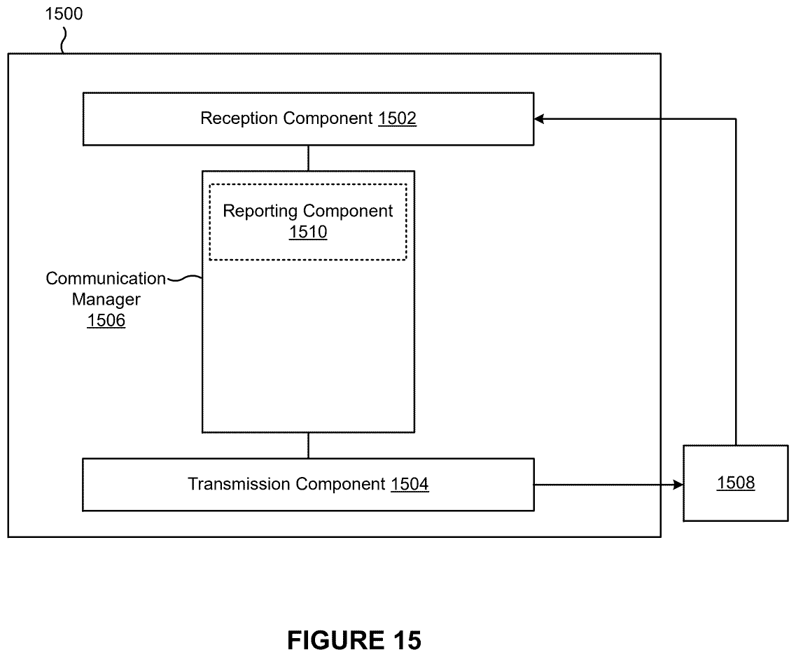

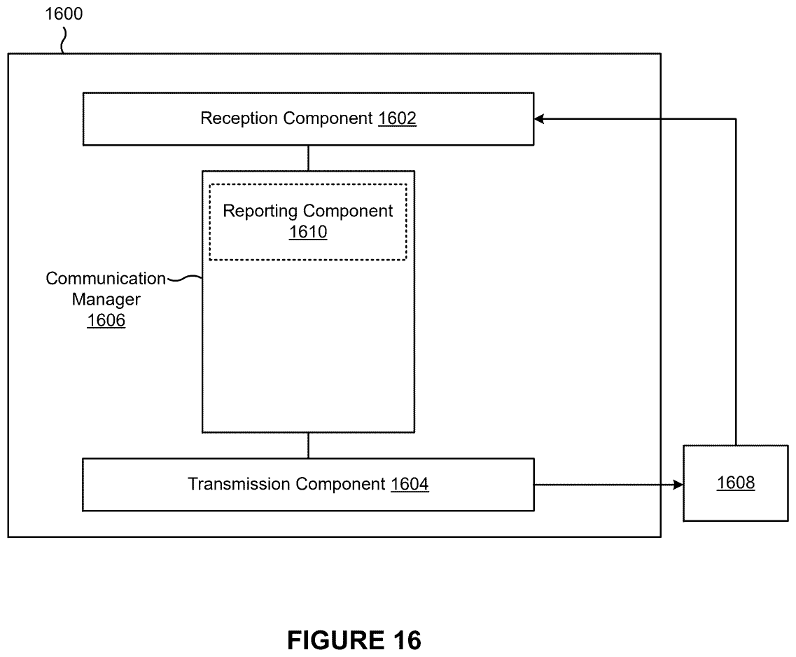

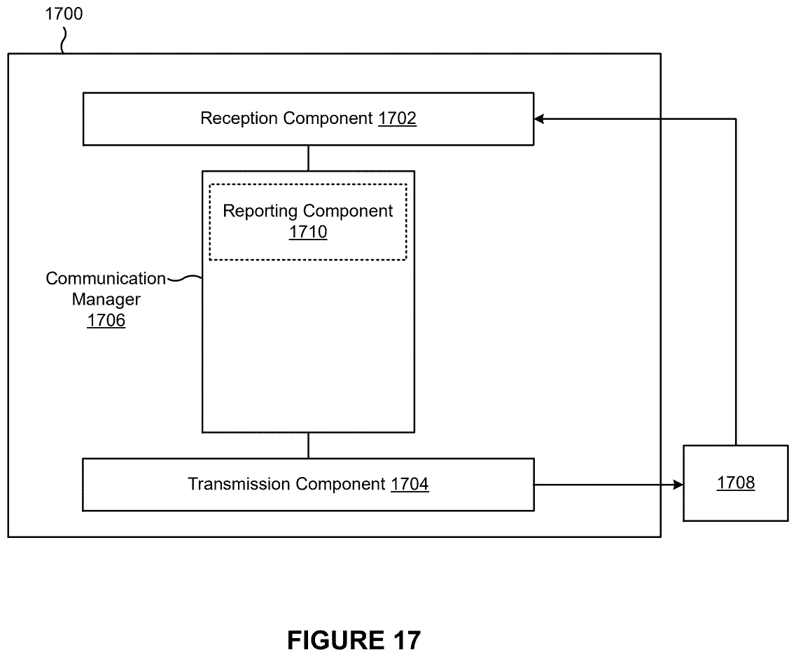

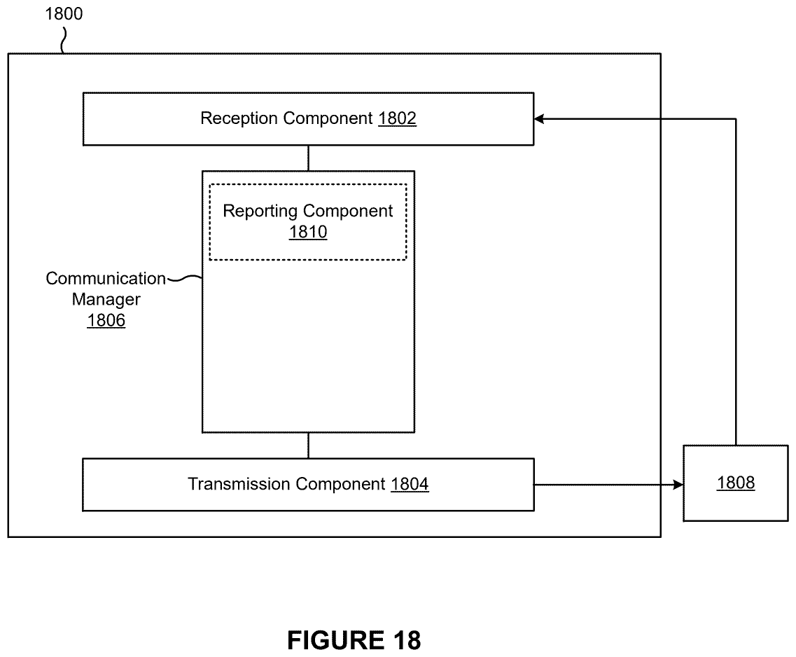

The means for the UE 120 to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15, reception component 1602 depicted and described in connection with FIG. 16, reception component 1702 depicted and described in connection with FIG. 17, or reception component 1802 depicted and described in connection with FIG. 18), or a transmission component (for example, transmission component 1504 depicted and described in connection with FIG. 15, transmission component 1604 depicted and described in connection with FIG. 16, transmission component 1704 depicted and described in connection with FIG. 17, or transmission component 1804 depicted and described in connection with FIG. 18), among other examples.

In some aspects, the network node 110 includes means for transmitting, to a UE, configuration information configuring a first quantity of L1 CLI measurement resources; or means for receiving, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range. In some other aspects, the network node 110 includes means for transmitting, to a UE, configuration information configuring a first quantity of L1 CLI measurement resources; or means for receiving, from the UE, a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.

In some other aspects, the network node 110 includes means for transmitting, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report; or means for receiving, from the UE, the measurement report in accordance with the configuration information. In some other aspects, the network node 110 includes means for transmitting, to a UE, configuration information configuring a periodic CLI measurement resource and a first QCL assumption for type D for the periodic CLI measurement resource; means for transmitting, to the UE, a MAC-CE updating the first QCL assumption to a second QCL assumption; or means for receiving, from the UE, a measurement report in accordance with the configuration information and the second QCL assumption.

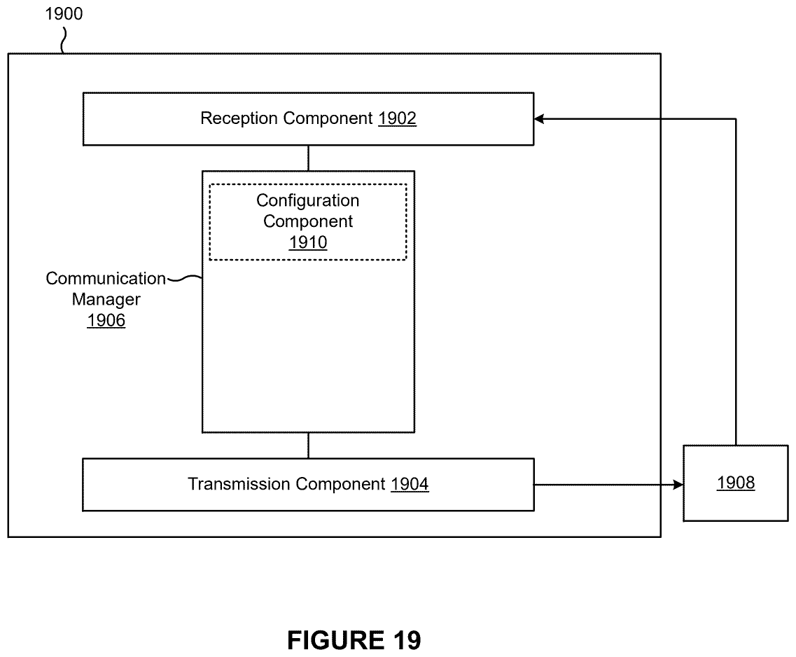

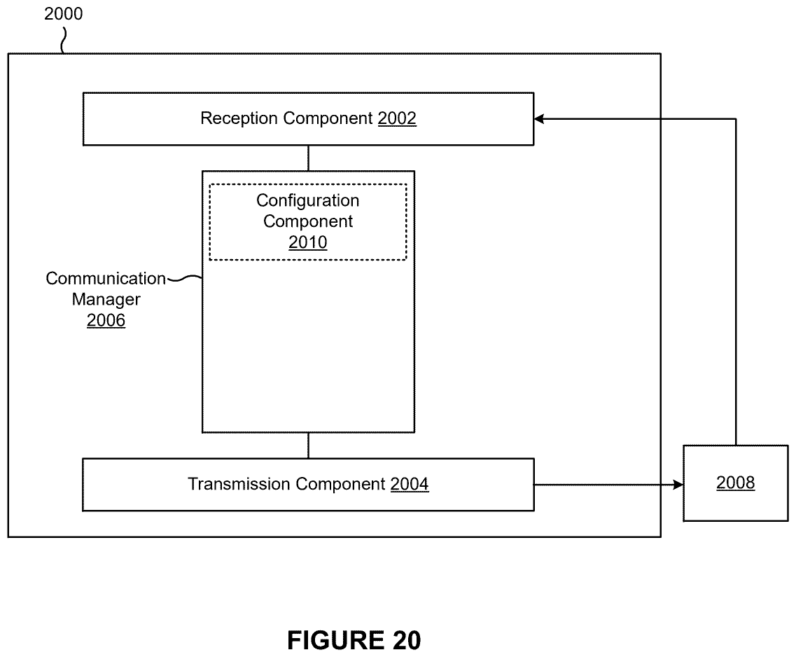

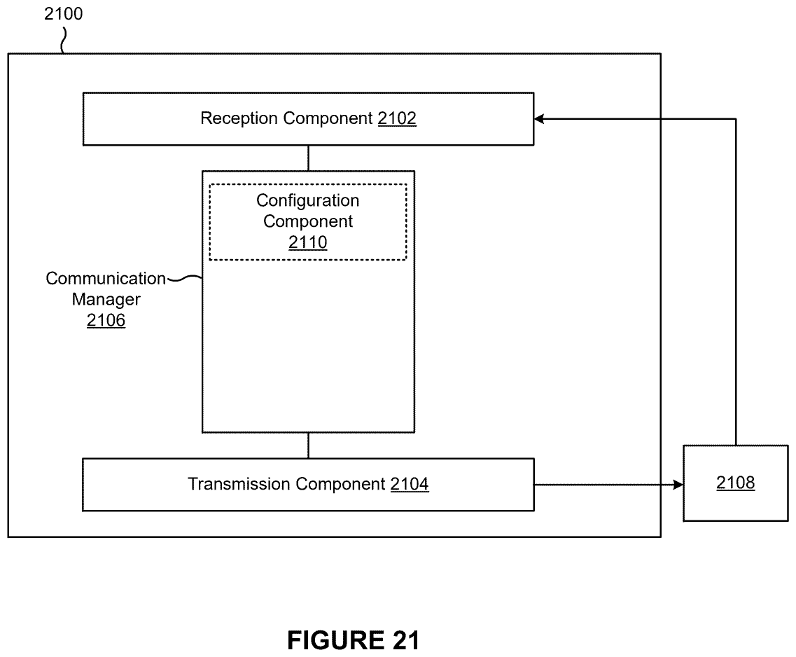

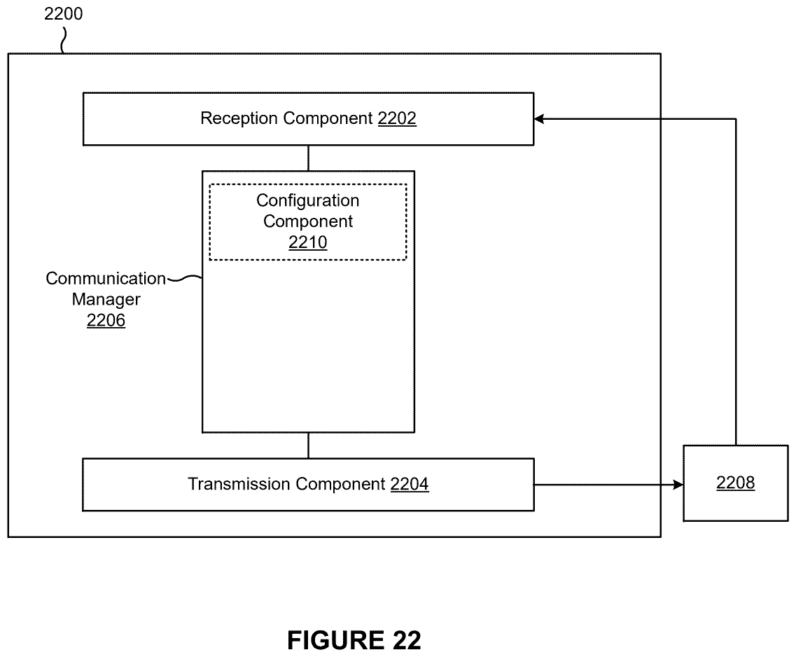

The means for the network node 110 to perform operations described herein may include, for example, one or more of communication manager 155, processing system 145, a radio, one or more RF chains, one or more transceivers, one or more antennas, one or more modems, a reception component (for example, reception component 1902 depicted and described in connection with FIG. 19, reception component 2002 depicted and described in connection with FIG. 20, reception component 2102 depicted and described in connection with FIG. 21, or reception component 2202 depicted and described in connection with FIG. 22), or a transmission component (for example, transmission component 1904 depicted and described in connection with FIG. 19, transmission component 2004 depicted and described in connection with FIG. 20, transmission component 2104 depicted and described in connection with FIG. 21, or transmission component 2204 depicted and described in connection with FIG. 22), among other examples.

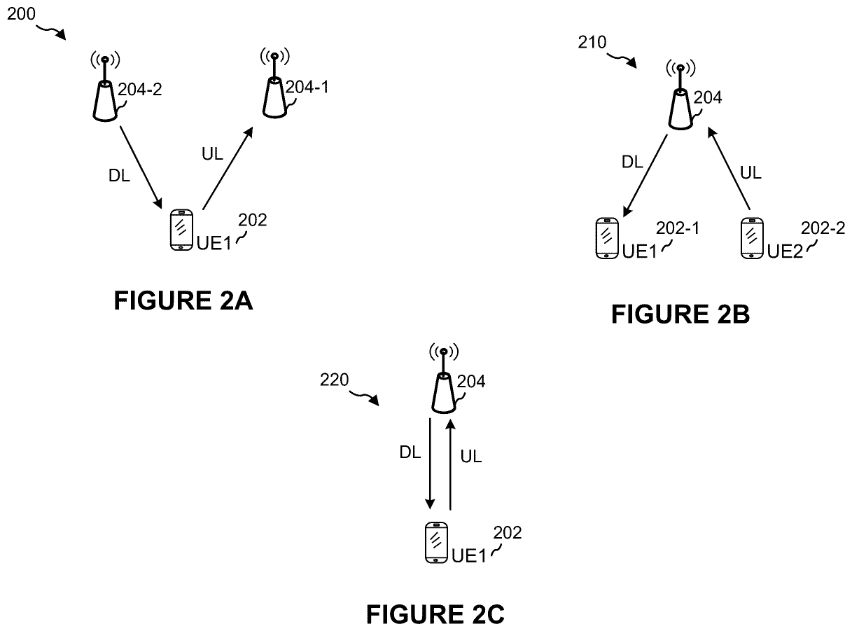

FIGS. 2A-2C are diagrams illustrating examples 200, 210, 220 of full duplex (FD) communication. “Full-duplex communication” in a wireless network refers to simultaneous bi-directional communication between devices in the wireless network. For example, a UE operating in a full-duplex mode may transmit an uplink communication and receive a downlink communication at the same time (for example, in the same slot or the same symbol). “Half-duplex communication” in a wireless network refers to unidirectional communications (for example, only downlink communication or only uplink communication) between devices at a given time (for example, in a given slot or a given symbol).

The example 200 of FIG. 2A includes a UE1 202 and two network nodes (for example, TRPs) 204-1, 204-2, where the UE1 202 is sending UL transmissions to network node 204-1 and is receiving DL transmissions from network node 204-2. In the example 200 of FIG. 2A, FD is enabled for the UE1 202, but not for the network nodes 204-1, 204-2. The example 210 of FIG. 2B includes two UEs, shown as UE1 202-1 and UE2 202-2, and a network node 204, where the UE1 202-1 is receiving a DL transmission from the network node 204 and the UE2 202-2 is transmitting an UL transmission to the network node 204. In the example 210 of FIG. 2B, FD is enabled for the network node 204, but not for UE 1 202-1 and UE2 202-2. The example 220 of FIG. 2C includes a UE1 202 and a network node 204, where the UE1 202 is receiving a DL transmission from the network node 204 and the UE1 202 is transmitting an UL transmission to the network node 204. In the example 220 of FIG. 2C, FD is enabled for both the UE1 202 and the network node 204.

As indicated above, FIGS. 2A-2C are provided as one or more examples. Other examples may differ from what is described with regard to FIGS. 2A-2C.

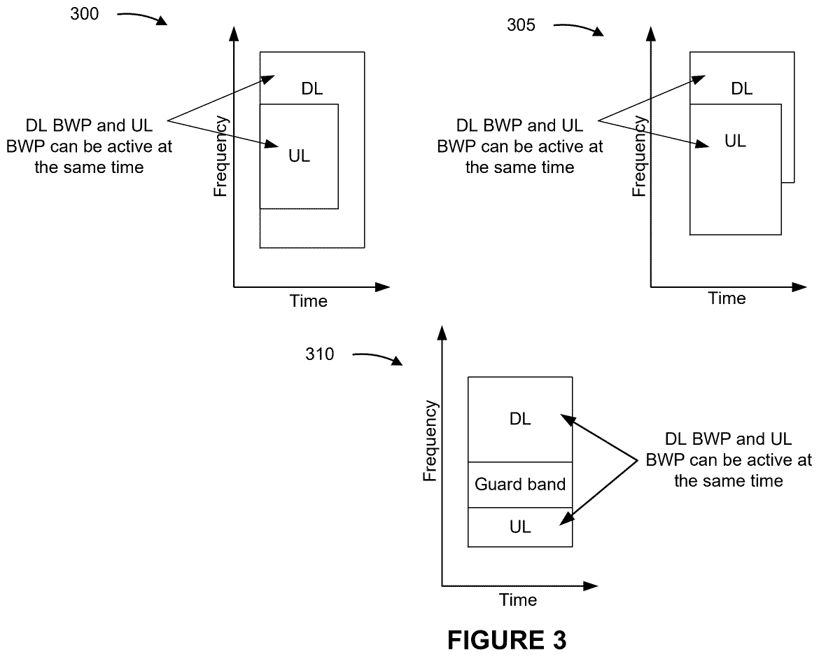

FIG. 3 is a diagram illustrating examples 300, 305, and 310 of full-duplex communication in a wireless network.

As shown in FIG. 3, examples 300 and 305 show examples of in-band full-duplex (IBFD) communication. In IBFD, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex (SBFDD)” or “flexible duplex.” At a high level, SBFD relates to simultaneous transmission and reception of downlink communications and uplink communications, respectively, on a sub-band basis. In SBFD, a network node may receive, from a first UE, an uplink communication and may transmit, to a second UE, a downlink communication at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band. In some examples, SBFD may increase an uplink duty cycle (for example, because the UE may be capable of transmitting uplink communications in an uplink sub-band of a semi-statically configured downlink set of symbols or flexible set of symbols), thus reducing uplink latency or improving uplink coverage. Additionally or alternatively, SBFD may enhance system capacity, resource utilization, or spectrum efficiency, as well as enable flexible and dynamic uplink/downlink resource adaption according to uplink/downlink traffic in a robust manner.

As indicated above, FIG. 3 is provided as an example. Other examples may differ from what is described with respect to FIG. 3.

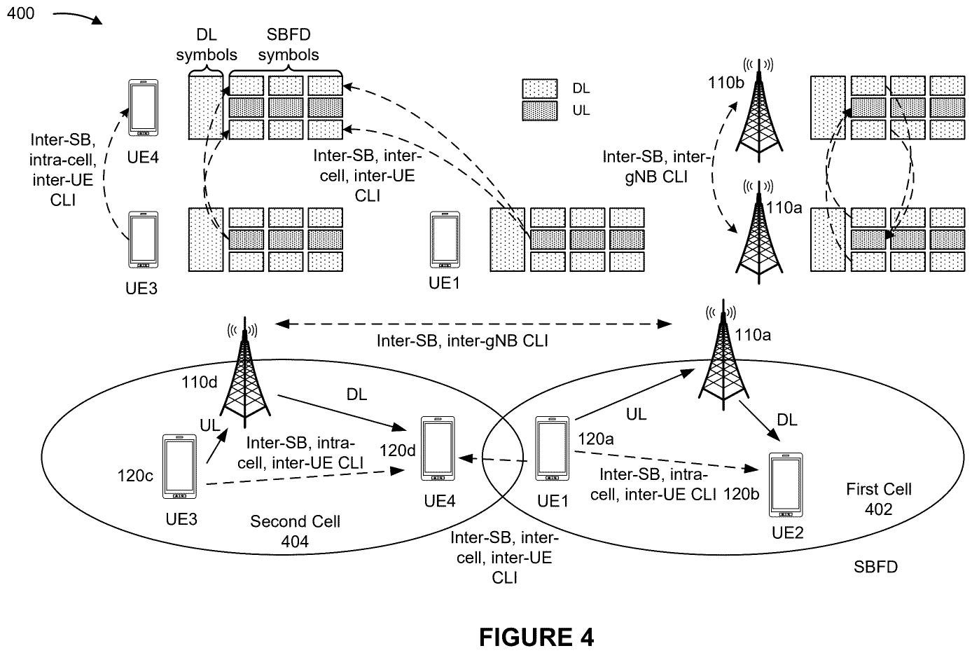

FIG. 4 is a diagram illustrating an example 400 of CLI associated with SBFD communications.

As shown in FIG. 4, in an SBFD scenario, a first network node 110a in a first cell 402 may receive an uplink transmission from a first UE 120a in the first cell 402, such as by using an uplink SB of an SBFD set of symbols (shown in FIG. 4 using dark stippling). The first network node 110a may transmit a downlink transmission to a second UE 120b in the first cell 402, such as by using a downlink SB of the SBFD set of symbols (shown in FIG. 4 using light stippling stippling). In such cases, the first UE 120a may cause an inter-SB, intra-cell, inter-UE CLI to the second UE 120b based at least in part on the uplink transmission of the first UE 120a. Similarly, a second network node 110b in a second cell 404 may receive an uplink transmission from a third UE 120c in the second cell 404 (for example, using an uplink SB of an SBFD set of symbols), and the second network node 110b may transmit a downlink transmission to a fourth UE 120d in the second cell 404 (for example, using a downlink SB of an SBFD set of symbols). Accordingly, the third UE 120c may cause an inter-SB, intra-cell, inter-UE CLI to the fourth UE 120d based at least in part on the uplink transmission of the third UE 120c. Moreover, the uplink transmission of the first UE 120a in the first cell 402 may cause an inter-SB, inter-cell, inter-UE CLI to the fourth UE 120d in the second cell 404 based at least in part on the uplink transmission of the first UE 120a. In some examples, the first network node 110a may cause an inter-SB, inter-gNB CLI to the second network node 110b, and vice versa. Put another way, downlink transmissions of the first network node 110a may cause the inter-SB, inter-gNB CLI to an uplink reception of the second network node 110b, and downlink transmissions of the second network node 110b may cause the inter-SB, inter-gNB CLI to an uplink reception of the first network node 110a.

As indicated above, FIG. 4 is provided as an example. Other examples may differ from what is described with regard to FIG. 4.

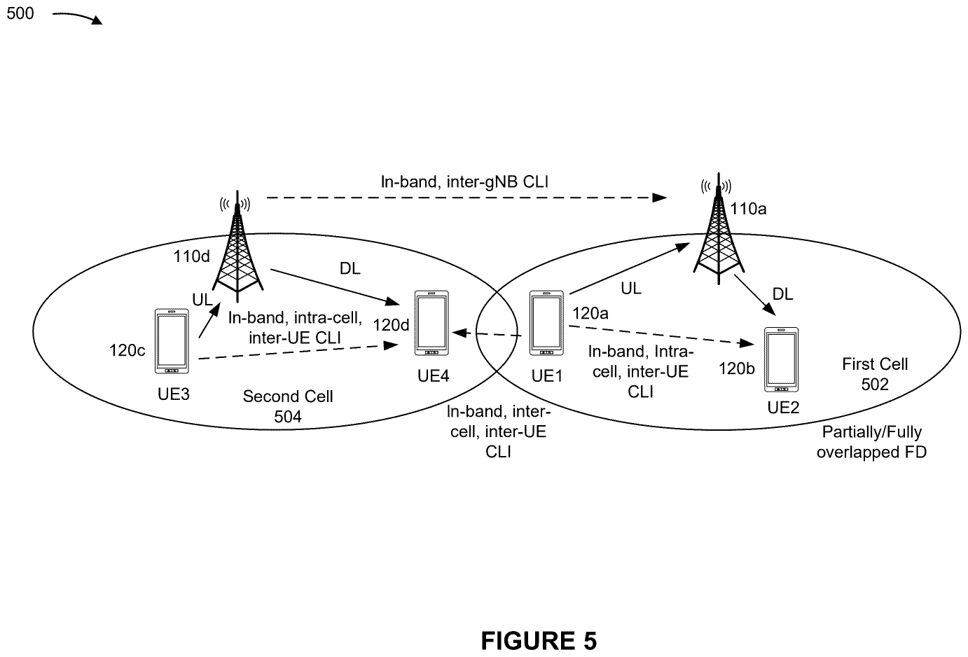

FIG. 5 is a diagram illustrating an example 500 of CLI associated with partially or fully overlapped FD communications.

As shown in FIG. 5, in a partially or fully overlapped FD scenario, a first network node 110a in a first cell 502 may receive an uplink transmission from a first UE 120a in the first cell 502. The first network node 110a may transmit a downlink transmission to a second UE 120b in the first cell 502. The first UE 120a may cause an in-band, intra-cell, inter-UE CLI to the second UE 120b based at least in part on the uplink transmission of the first UE 120a. Similarly, a second network node 110d in a second cell 504 may receive an uplink transmission from a third UE 120c in the second cell 504. The second network node 110d may transmit a downlink transmission to a fourth UE 120d in the second cell 504. The third UE 120c may cause an in-band, intra-cell, inter-UE CLI to the fourth UE 120d based at least in part on the uplink transmission of the third UE 120c. Further, the first UE 120a in the first cell 502 may cause an in-band, inter-cell, inter-UE CLI to the fourth UE 120d in the second cell 504 based at least in part on the uplink transmission of the first UE 120a. Further, the first network node 110a may cause an in-band, inter-gNB CLI to the second network node 110d, and vice versa. Put another way, downlink transmissions of the first network node 110a may cause the in-band, inter-gNB CLI to an uplink reception of the second network node 110b, and downlink transmissions of the second network node 110b may cause the in-band, inter-gNB CLI to an uplink reception of the first network node 110a.

As indicated above, FIG. 5 is provided as an example. Other examples may differ from what is described with regard to FIG. 5.

In some examples, a network node 110 may configure a UE 120 to measure and report CLI, such as the inter-UE CLI described above in connection with FIGS. 4 and 5. More particularly, the network node 110 may configure the UE 120 with one or more resources for performing CLI measurements, such as L1 CLI measurements, among other examples, or one or more resources for transmitting one or more measurement reports, such as one or more L1 measurement reports, among other examples. Such measurement and reporting procedures may result in relatively high resource consumption associated with the various measurements and reports. For example, reporting absolute measurement values for each configured inter-UE CLI measurement resource may result in high computing, power, and network resource consumption. In some examples, in order to reduce overhead associated with such reporting, a network node 110 may configure a UE 120 to report CLI relatively infrequently or for only a few measurement resources, which may result in reduced information exchange between the network node 110 and the UE 120, and thus poor communication channels, increased communication errors, and high power, computing, and network resource consumption for correcting communication errors.

Some aspects and techniques described herein enable improved measurement and reporting procedures, such as improved CLI measurement and reporting procedures. In some aspects, a network node may configure a UE to measure L1 CLI measurement resources, and a UE may transmit a measurement report for a quantity of L1 CLI measurement resources that indicates that at least one measurement result is out-of-range. For example, the measurement report may indicate that a first measurement result (for example, an absolute measurement result for a most interfered measurement resource) is larger than a largest value of the measurement range by indicating a first codepoint that maps to a largest value of a measurement range in an L1 CLI absolute codebook. Similarly, the measurement report may indicate that one or more additional measurement results are out of range, such as by indicating that a second measurement result (for example, a differential measurement result for a second most interfered measurement resource) is larger than a largest value of the measurement range by indicating a first codepoint that maps to an out-of-range value in an L1 CLI differential codebook.

In some other aspects, the measurement report may indicate measurement results using an improved differential reporting method. In such aspects, the measurement report may indicates a first measurement result (for example, a measurement result for a most interfered measurement resource), such as by indicating an absolute value of the first measurement result.

The measurement report may further indicate a second measurement result (for example, a measurement result for a second most interfered measurement resource) by indicating a first difference between the first measurement result and the second measurement result. Similarly, the measurement report may further indicate a third measurement result (for example, a measurement result for a third most interfered measurement resource) by indicating a second difference between the second measurement result and the third measurement result, and so forth for the remaining measurement results.

In some other aspects, the network node may configure the UE with certain parameters used to report measurement results in a measurement report. For example, the network node may transmit, to the UE, configuration information configuring at least one of a quantity of bits for a codepoint used to report measurement results in a measurement report (for example, a codepoint used to report an absolute measurement result or a differential measurement result), a measurement range used to report the measurement results in the measurement report (for example, a measurement range associated with an absolute codebook or a differential codebook), a codebook resolution used to report the measurement results in the measurement report (for example, a step size for the absolute codebook or the differential codebook), or one or more events that trigger the measurement report.

In some other aspects, the network node may update one or more parameters associated with a measurement report using a MAC-CE. More particularly, the network node may transmit, to the UE, configuration information configuring a periodic measurement resource having first QCL assumption for type D. If the network node thereafter needs to update the QCL assumption, rather than RRC reconfiguring the UE, the network node may transmit a MAC-CE updating the first QCL assumption to a second QCL assumption. The UE may thus measure the periodic CLI measurement resource in accordance with the second QCL assumption, and may transmit a measurement report in accordance with the configuration information and the second QCL assumption.

As a result, the aspects described herein enable differential reporting that result in reduced computing, power, and network resource consumption. In this way, the aspects described herein may enable more frequent measurement reports or reporting measurement results for more measurement resources, which may result in increased information exchange between the network node and the UE and thus improved communication channels, decreased communication errors, and reduced power, computing, and network resource consumption otherwise required for correcting communication errors.

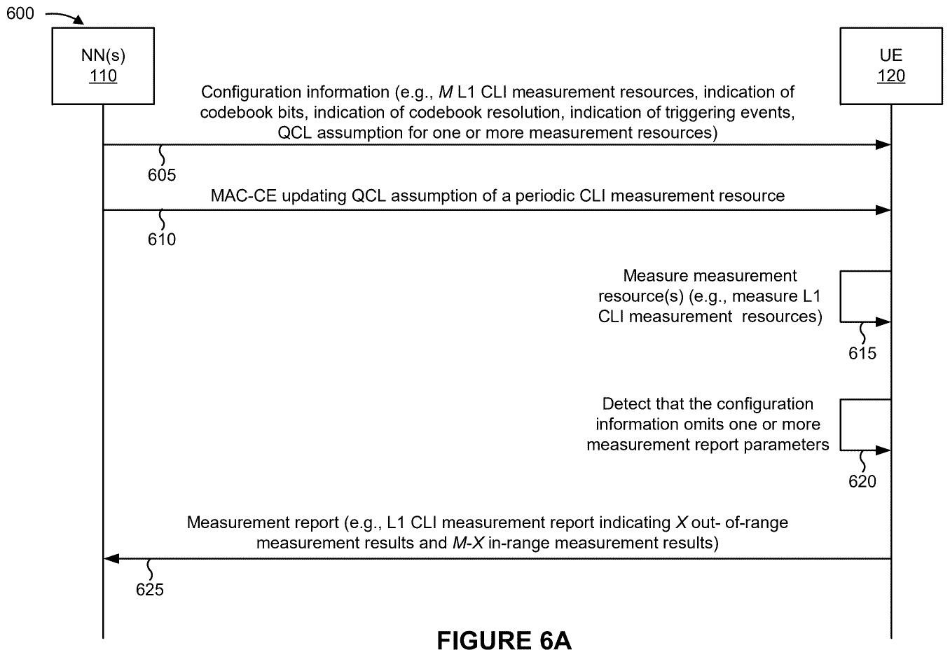

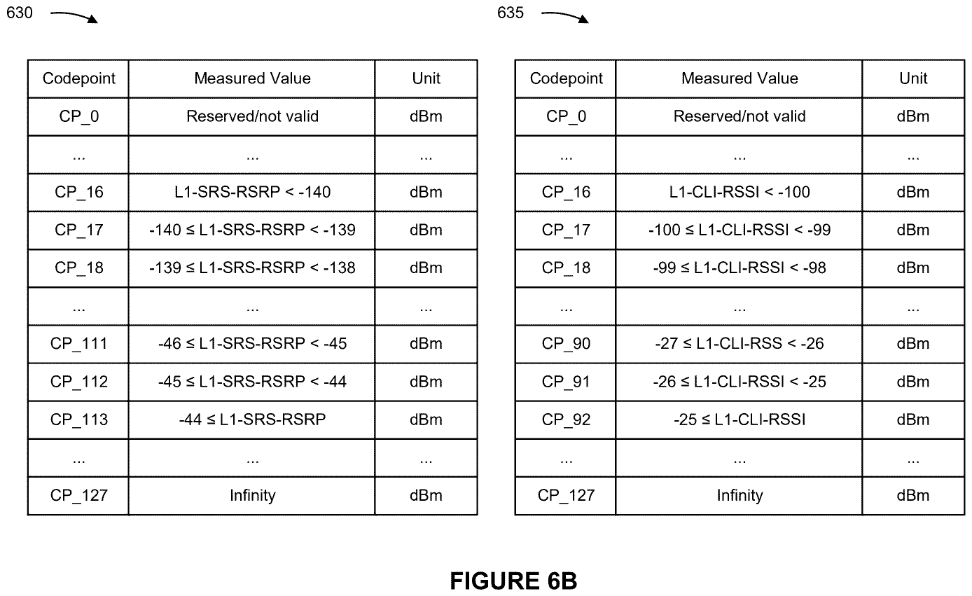

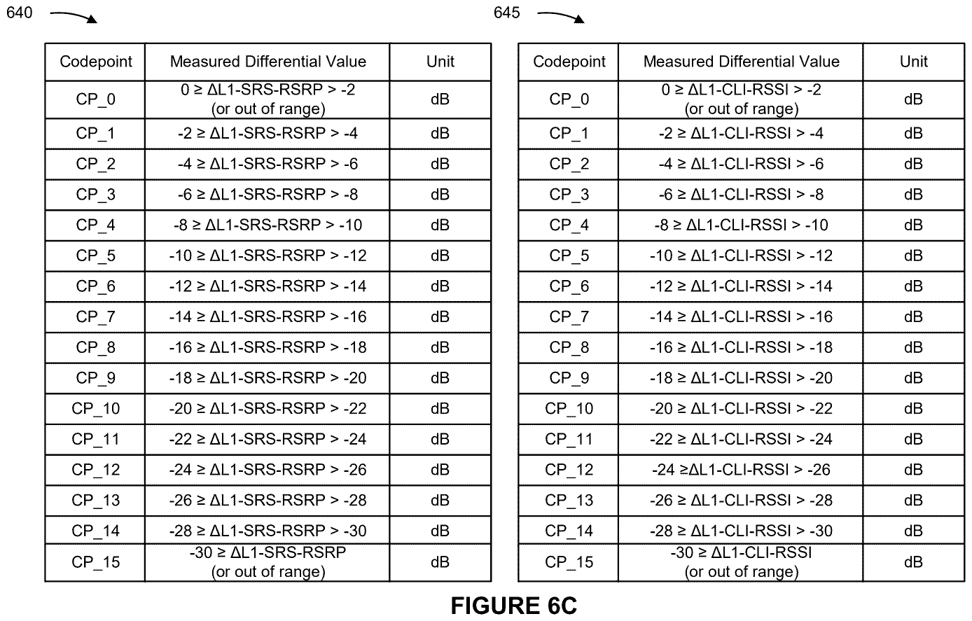

FIGS. 6A-6C are diagrams of examples associated with CLI measurement and reporting. As shown in FIG. 6A, and by example 600, a network node 110 (for example, a base station, a CU, a DU, or an RU) may communicate with a UE 120. In some aspects, the network node 110 and the UE 120 may be part of a wireless network (for example, the wireless communication network 100). The UE 120 and the network node 110 may have established a wireless connection prior to operations shown in FIG. 6A. In some aspects, the network node 110 or the UE 120 may be capable of FD communication, such as SBFD communication. For example, the network node 110 may be capable of simultaneous uplink reception and downlink transmission in an SBFD set of symbols, and the UE 120 may be an SBFD-aware UE 120 is aware of the network node 110's SBFD operation.

In a first operation 605, the network node 110 may transmit, and the UE 120 may receive, configuration information. In some aspects, the UE 120 may receive the configuration information via one or more of system information signaling (for example, a master information block (MIB) or a system information block (SIB), among other examples), RRC signaling, MAC signaling (for example, one or more MAC-CEs), or physical layer signaling (for example, DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (for example, a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (for example, an original equipment manufacturer (OEM) configuration). In some aspects, the configuration information may include a parameter or index that is indicative of information defined, or otherwise fixed, by a wireless communication standard, such as the 3GPP (for example, rather than explicitly indicating the information).

In some aspects, the configuration information may configure a first quantity of L1 CLI measurement resources to be used by the UE 120 for measuring and reporting CLI, such as the inter-UE CLI described above in connection with FIGS. 4 and 5. For example, the L1 CLI measurement resources may be L1 sounding reference signal reference signal received power (L1-SRS-RSRP) resources, L1 CLI received signal strength indicator (L1-CLI-RSSI) resources, or similar resources. In some other aspects, the configuration information may configure different types of measurement resources, such as measurement resources associated with a different type of L1 measurement report or resources associated with an L3 measurement report, among other examples. For example, the measurement resources may be associated with an L3-CLI-RSSI report, an L3-SRS-RSRP report, an L1-RSRP report, an L1 signal-to-inference-plus-noise ratio (L1-SINR) report, or a similar L3 or L1 report.

As described in more detail below in connection with a fifth operation 625 and FIGS. 6B and 6C, in some aspects the UE 120 may report measurement results using codepoints corresponding to absolute values of certain measurement results or else differential values of certain measurement results. In some aspects, the codepoints used to report the measurement results may be fixed or predefined (for example, via a relevant wireless communication standard, such as a standard promulgated by the 3GPP). For example, for L 1-SRS-RSRP measurement and reporting, a 7-bit value in the quantization range [−140, −44] decibel-milliwatts (dBm) with 1 dB step size may be used to report a largest (for example, most interfered) measurement result, and a 4-bit value may be used to report differential L1-SRS-RSRP measurement results, with each differential L1-SRS-RSRP value being computed with a 2 dB step size and with reference to the largest measured L1-SRS-RSRP value. Moreover, for L1-CLI-RSSI measurement and reporting, a 7-bit value in the quantization range [−100, −25] dBm with 1 dB step size may be used to report a largest (for example, most interfered) measurement result, and a 4-bit value may be used to report differential L1-CLI-RSSI measurement results, with each differential L1-CLI-RSSI value being computed with a 2 dB step size and with reference to the largest measured L1-CLI-RSSI value.

However, to save signaling overhead or to enable increased flexibility, in some other aspects the configuration information may indicate one or more parameters to be used to report the absolute values or differential values. For example, the configuration information may configure a quantity of bits for a codepoint used to report measurement results in a measurement report, a measurement range used to report measurement results in a measurement report, a codebook resolution used to report the measurement results in the measurement report (for example, a step size of the measurement range), one or more events that trigger the measurement report, or similar parameters. Put another way, the network node may configure, for L1 or L3 reporting (for example L3-CLI-RSSI, L3-SRS-RSRP, L1-CLI-RSSI, L1-SRS-RSRP, L1-RSRP, L1-SINR, or similar L1 or L3 measurement or reporting) one or more of a measurement range or number of bits used to report absolute or differential measurement results, a step size or resolution for reporting absolute or differential measurement results, one or more events that trigger the measurement report, or a similar parameter.

In aspects in which the configuration information configures the quantity of bits for the codepoint used to report measurement results, the measurement range used to report measurement results, the codebook resolution used to report the measurement results, one or more events that trigger the measurement report, or similar parameters, the configuration information may be indicated via one of a measurement report configuration information element (IE) (for example, reportConfig) or a measurement resource configuration IE. In some other aspects, the configuration information that configures the quantity of bits for the codepoint used to report measurement results, the measurement range used to report measurement results, the codebook resolution used to report the measurement results, one or more events that trigger the measurement report, or similar parameters, may be indicated via or a new RRC signaling (for example, a dedicated RRC signaling for indicating the at least one of the quantity of bits for the codepoint, the measurement range, the codebook resolution or step size, or the one or more events, among other information).

In some aspects, measurement resources indicated by the configuration information may be periodic measurement resources. Put another way, the configuration information may configure at least one periodic CLI measurement resource. In such aspects, the configuration information may further configure a QCL assumption for the periodic CLI measurement resource, such as a QCL assumption for type D (sometimes referred to herein as QCL-type D) with a corresponding TCI state for the periodic CLI measurement resource. For example, the configuration information may configure at least one of a periodic SRS-RSRP resource or a periodic CLI-RSSI resource, and may indicate a corresponding QCL assumption (for example, QCL assumption for type D) and corresponding TCI state for the periodic SRS-RSRP resource or the periodic CLI-RSSI resource.

Put another way, for a periodic or aperiodic L1 CLI reporting (for example, CLI-RSSI or SRS-RSRP reporting) on PUSCH based on a set of periodic CLI measurement resources, the TCI state(s) with QCL-type D for the CLI measurement resources in the periodic CLI measurement resource set may be configured per CLI measurement resource (either for all resources in the set or none) by a higher-layer parameter. In such aspects, for each periodic CLI measurement resource, this higher-layer parameter may provide a reference to one TCI state in a set of TCI states for providing the QCL source and QCL-type D. In some aspects, if a TCI state is not configured, the UE 120 may apply QCL assumption using one or more default rules, among other examples.

The UE 120 may configure itself based at least in part on the configuration information. In some aspects, the UE 120 may be configured to perform one or more operations described herein based at least in part on the configuration information.

In a second operation 610, the network node 110 may transmit, and the UE 120 may receive, a MAC-CE that updates a QCL assumption associated with a periodic measurement resource to a second QCL assumption. More particularly, as described above in connection with the first operation 605, a QCL assumption (for example, QCL-type D) may be configured for each periodic CLI measurement resource (for example, for each periodic CLI SRS-RSRP or CLI-RSSI measurement resource). In such aspects, if a beam associated with a measurement resource is updated, the network node 110 may need to update the QCL assumption. Accordingly, in order to reduce latency associated with RRC reconfiguring the periodic measurement resource or otherwise, the network node 110 may transmit the MAC-CE shown in connection with the second operation 610 to update a QCL assumption (for example, QCL-type D) with a TCI state for a periodic CLI measurement resource (for example, a periodic CLI SRS-RSRP measurement resource or a periodic CLI-RSSI measurement resource). In this way, the network node 110 and the UE 120 do not need to use RRC reconfiguration of a periodic measurement resource if only a QCL-type D assumption needs updated.

In a third operation 615, the UE 120 may measure one more measurement resources, such as one or more of the L1 CLI measurement resources or one or more periodic measurement resources described above in connection with the first operation 605. For example, in aspects in which the one or more measurement resources are associated with CLI SRS-RSRP resources, the UE 120 may perform RSRP measurements. Similarly, in aspects in which the one or more measurement resources are associated with CLI-RSSI resources, the UE 120 may perform RSSI measurements. Moreover, in aspects in which the network node 110 updates a QCL assumption (for example, QCL-type D) using the MAC-CE described above in connection with the second operation 610, the UE 120 may measure the measurement resources in accordance with the updated QCL assumption.

As described above in connection with the first operation 605, in some aspects the configuration information may configure one or more parameters associated with reporting measurement results, such as the quantity of bits for the codepoint used to report measurement results, the measurement range used to report measurement results, the codebook resolution used to report the measurement results, one or more events that trigger the measurement report, or similar parameters. In such aspects, if any parameters are absent from the configuration information, then a default parameter (for example, a legacy parameter) may be used by the UE 120 for reporting the measurement results. Put another way, if the configuration information omits configuration of the quantity of bits for the codepoint used to report measurement results, the measurement range used to report measurement results, the codebook resolution used to report the measurement results, or one or more events that trigger the measurement report, the UE 120 may use the legacy quantity of bits for the codepoint used to report measurement results, the legacy measurement range used to report measurement results, the legacy codebook resolution used to report the measurement results, or the legacy events that trigger the measurement report, respectively.

Accordingly, in a fourth operation 620, the UE 120 may detect that the configuration information omits one or more indications corresponding to one or more of the quantity of bits for the codepoint, the measurement range used to report measurement results, the codebook resolution, or the one or more events. Additionally or alternatively, the UE 120 may, in response, prepare or transmit a measurement report (described in more detail below in connection with the fifth operation 625) in accordance with one or more of a default quantity of bits for the codepoint, a default measurement range, a default codebook resolution, or a default set of events.

In the fifth operation 625, the UE 120 may transmit, and the network node 110 may receive, a measurement report. The measurement report may indicate measurement results for one or more of the configured measurement resources (for example, one or more of the measurement resources measured by the UE 120, as described above in connection with the third operation 615). For example, the configuration information may configure a first quantity of measurement resources (for example, L1 CLI measurement resources), and the measurement report may indicate measurement results for a second quantity of the measurement resources, with the second quantity being less than or equal to the first quantity. More particularly, the network node 110 may configure the UE 120 with N measurement resources or may configure the UE 120 to report the M largest measurement results (where M≤N), and thus the measurement report may include M measurement results. Additionally or alternatively, in some aspects, the measurement report may be an L3 measurement report, such as an L3-CLI-RSSI report or an L3-SRS-RSRP report, among other examples. In some other aspects, the measurement report may be an L1 measurement report, such as an L1-CLI-RSSI report, an L1-SRS-RSRP report, an L1-RSRP report, or an L1-SINR report, among other examples.

In some aspects, the configuration information described above in connection with the first operation 605 may configure the measurement report by using a CSI report configuration IE (sometimes referred to herein as CSI-ReportConfig) with a higher layer parameter (sometimes referred to herein as reportQuantity) set to an indication used to indicate that the measurement report is to be used to report CLI, such as by being set to one of a CLI-RSSI indication (sometimes referred to herein as cli-RSSI, such as when the measurement resources or report are associated with L1-CLI-RSSI resources) or a CLI-SRS-RSRP indication (sometimes referred as cli-SRS-RSRP, such as when the measurement resources or report are associated with L1-SRS-RSRP resources). In such aspects, the number of reported CLI measurement resources, M, may be configured (such as one of {1, 2, 3, 4}), and the measurement report may in turn include M CLI measurement resource identifiers (IDs) of the M measurement resources being reported. In some aspects, each ID of the M measurement resources being reported may be a measurement resource index (MRI). For example, an index or ID of an SRS-RSRP measurement resource may be referred to as an SRS-RSRP-MRI and an index or ID of a CLI-RSSI measurement resource may be referred to as an CLI-RSSI-MRI.

In some aspects, the measurement report may indicate an absolute value of a largest (for example, most interfered) measurement result, as well as a differential measurement result (for example, a difference between a measured value and the most interfered value) for each remaining measurement result (for example, for the remaining M-1 measurement results). Put another way, the measurement report may report the absolute value of the most interfered (largest) measurement result (for example, the largest measured L1-CLI-RSSI or L1-SRS-RSRP) as a reference, and, when the number of reported CLI measurement resources is larger than one (for example, when M>1), the report may use a differential reporting method taking the most interfered measurement result (for example, the most interfered measured L1-CLI-RSSI or L1-SRS-RSRP) as the reference.

In that regard, in aspects in which a CSI report configuration IE (for example, CSI-ReportConfig) with a higher layer parameter (for example, reportQuantity) set to an indication used to indicate that the measurement report is to be used to report CLI, a mapping order of CSI fields of one CSI report (sometimes referred to herein as CSI report #n) for SRS-RSRP-MRI/SRS-RSRP reporting or CLI-RSSI-MRI/CLI-RSSI reporting may include: one or more (for example, up to four, in some aspects) SRS-RSRP-MRIs (if reported), or else one or more (for example, up to four, in some aspects) CLI-RSSI-MRIs (if reported); followed by an absolute L1-SRS-RSRP measurement result for a most interfered measurement resource (if reported), or else an absolute L1-CLI-RSSI measurement result for a most interfered measurement resource (if reported); one or more (for example, up to three, in some aspects) differential L1-SRS-RSRP measurement results (if reported), or else one or more (for example, up to three, in some aspects) differential L1-CLI-RSSI measurement results (if reported).

In some aspects, a bitwidth of a field used to report SRS-RSRP-MRI may be equal to ┌log₂(Kₛ^{SRS-RSRP})┐, where Kₛ^{SRS-RSRP} is the number of SRS-RSRP measurement resources in a corresponding resource set. Similarly, a bitwidth of a field used to report CLI-RSSI-MRI may be equal to ┌log₂(Kₛ^{CLI-RSSI})┐, where Kₛ^{CLI-RSSI} is the number of CLI-RSSI measurement resources in a corresponding resource set. Moreover, in some aspects, a bitwidth of a field used to report an absolute L1-SRS-RSRP measurement result or an absolute L1-CLI-RSSI measurement result may be 7 bits, and a bitwidth of a field used to report a differential L1-SRS-RSRP measurement result or a differential L1-CLI-RSSI measurement result may be 4 bits. In some other aspects, a bitwidth of a field used to report an absolute L1-SRS-RSRP measurement result, an absolute L1-CLI-RSSI measurement result, a differential L1-SRS-RSRP measurement result, or a differential L1-CLI-RSSI measurement may be variable and thus may be configured by the configuration information, as described above in connection with the first operation 605.

This may be more readily understood with reference to FIGS. 6B and 6C. FIG. 6B shows example L1 CLI absolute codebooks 630, 635 that may be used to report absolute L1-SRS-RSRP measurement results or absolute L1-CLI-RSSI measurement results, respectively. The L1 CLI absolute codebooks 630, 635 may be associated with a number of codepoints used to report the absolute measurement results. For example, in aspects in which a bitwidth of a field used to report an absolute L1-SRS-RSRP measurement is 7 bits, the L1 CLI absolute codebook 630 may be associated with up to 2⁷ (for example, 128) codepoints, shown in connection with the L1 CLI absolute codebook 630 as a first codepoint (indexed CP_0) through a 128^{th} codepoint (indexed CP_127).

In such aspects, and with respect to the L1 CLI absolute codebook 630, a subset of the codepoints may correspond to L1-SRS-RSRP measurement results that fall within a measurement range, such as [−140, −44] dBm. For example, CP_16 (for example, 0010000) may correspond to L1-SRS-RSRPs that are less than −140 dBm, CP_17 (for example, 0010001) may correspond to L1-SRS-RSRPs that are greater than or equal to −140 dBm but less than −139 dBm, CP_18 (for example, 0010010) may correspond to L1-SRS-RSRPs that are greater than or equal to −139 dBm but less than −138 dBm, and so forth, such that CP_113 (for example, 1110001) may correspond to L1-SRS-RSRPs that are greater than or equal to −44 dBm. In some other aspects, a different subset of the codepoints (for example, codepoints other than 0010000 through 1110001) may be used to represent the L1-SRS-RSRP measurement results that fall within a measurement range, such as [−140, −44] dBm.

Similarly, with respect to the L1 CLI absolute codebook 635, a subset of the codepoints may correspond to L1-CLI-RSSI measurement results that fall within a measurement range, such as [−100, −25] dBm. For example, CP_16 (for example, 0010000) may correspond to L1-CLI-RSSIs that are less than −100 dBm, CP_17 (for example, 0010001) may correspond to L1-CLI-RSSIs that are greater than or equal to −100 dBm but less than −99 dBm, CP_18 (for example, 0010010) may correspond to L1-CLI-RSSIs that are greater than or equal to −99 dBm but less than −98 dBm, and so forth, such that CP_92 (for example, 1011100) may correspond to L1-CLI-RSSIs that are greater than or equal to −25 dBm. In some other aspects, a different subset of the codepoints (for example, codepoints other than 0010000 through 1011100) may be used to represent the L1-CLI-RSSI measurement results that fall within a measurement range, such as [−100, −25] dBm.

Moreover, FIG. 6C shows example L1 CLI differential codebooks 640, 645 that may be used to report differential L1-SRS-RSRP measurement results and differential L1-CLI-RSSI

measurement results, respectively. The L1 CLI differential codebooks 640, 645 may be associated with a number of codepoints used to report differential L1-SRS-RSRP measurement results. For example, in aspects in which a bitwidth of a field used to report a differential L1-SRS-RSRP measurement result is 4 bits, the L1 CLI differential codebooks 640, 645 may be associated with up to 2⁴ (for example, 16) codepoints, shown in connection with the L1 CLI differential codebooks 640, 645 as a first codepoint (indexed CP_0) through an sixteenth codepoint (indexed CP_15).

In such aspects, and with respect to the L1 CLI differential codebook 640, CP_0 (for example, 0000) may correspond to differential L1-SRS-RSRPs (shown in FIG. 6C as “ΔL1-SRS-RSRP”) that are less than or equal to 0 and greater than −2 dB, CP_1 (for example, 0001) may correspond to differential L1-SRS-RSRPs that are less than or equal to-2 dB but greater than −4 dB, CP_2 (for example, 0010) may correspond to differential L1-SRS-RSRPs that are less than or equal to −4 dB but greater than −6 dBm, and so forth, such that CP_15 (for example, 1111) may correspond to differential L1-SRS-RSRPs that are less than or equal to −30 dBm. Similarly, and with respect to the L1 CLI differential codebook 645, CP_0 (for example, 0000) may correspond to differential L1-CLI-RSSIs (shown in FIG. 6C as “ΔL1-CLI-RSSI”) that are less than or equal to 0 and greater than −2 dB, CP_1 (for example, 0001) may correspond to differential L1-CLI-RSSIs that are less than or equal to −2 dB but greater than −4 dB, CP_2 (for example, 0010) may correspond to differential L1-CLI-RSSIs that are less than or equal to −4 dB but greater than −6 dBm, and so forth, such that CP_15 (for example, 1111) may correspond to differential L1-CLI-RSSIs that are less than or equal to −30 dBm.

In some other aspects, one or more parameters described above in connection with FIGS. 6B-6C may be configured by the network node 110, as described above in connection with the first operation 605. For example, the configuration information may configure a quantity of bits for a codepoint used to report measurement results in a measurement report (for example, a bitwidth field to be used for reporting absolute or differential measurement results), a measurement range used to report the measurement results in the measurement report (for example, a range of values in one or more of the tables shown in FIGS. 6B and 6C), a codebook resolution used to report the measurement results in the measurement report (for example, a step size in the one or more tables described above in connection with FIGS. 6B-6C, such as 1 dBm/dB, 2 dBm/dB, 3 dBm/dB, and so forth), among other examples.

In some aspects, the measurement report may indicate that one or more measurement results are out of range of the respective measurement range indicated by one of the tables described above in connection with FIGS. 6B-6C or else indicated by the configuration information described above in connection with the first operation 605. For example, in aspects in which the measurement report is used to indicate L1-SRS-RSRP measurement results within the range [−140, −44] dBm, if a measurement result exceeds −44 dBm, the measurement report may indicate a codepoint that is used to indicate that the measurement result is larger than −44 dBm. Similarly, in aspects in which the measurement report is used to indicate L1-CLI-RSSI measurement results within the range [−100, −25] dBm, if a measurement result exceeds −25 dBm, the measurement report may indicate a codepoint that is used to indicate that the measurement result is larger than −25 dBm.

For example, in some aspects, a most interfered L1/SRS-RSRP measurement result or L1-CLI-RSSI measurement result may be reported using 7 bits, as described above. In some aspects, the 7 bits may be set to a codepoint mapping to “infinity” to indicate that the most interfered measurement result is out of range (for example, larger than −44 dBm for L1-SRS-RSRP aspects or larger than −25 dBm for L1-CLI-RSSI aspects). For example, as shown in connection with the L1 CLI absolute codebooks 630, 635 in FIG. 6B, CP_127 (for example, 1111111) may be used to indicate that a most interfered measurement result is out of range. In some other aspects, a different codepoint or indicator may be used to indicate that a most interfered measurement result is out of range. For example, in some aspects, the out-of-range indicator may correspond to a codepoint mapping to a largest value in an L1 CLI absolute codebook, such as CP_113 in the L1 CLI absolute codebook 630 (for example, the codepoint mapping to L1-SRS-RSRP≥−44 dBm) or CP_92 in the L1 CLI absolute codebook 635 (for example, the codepoint mapping to L1-CLI-RSSI≥−25 dBm).

Additionally or alternatively, in some aspects, any measurement results that are not a most interfered measurement result may be reported using 4 bits, as described above. In some aspects, the 4 bits used to report an out-of-range measurement result may be set to a codepoint that maps to an out-of-range value in an L1 CLI differential codebook 640, 645. In some aspects, the out-of-range value may correspond to a codepoint mapping to a largest value in an L1 CLI differential codebook, such as CP_0 in the L1 CLI differential codebook 640 (for example, the codepoint mapping to 0≥ΔL1-SRS-RSRP>−2 dB) or CP_0 in the L1 CLI differential codebook 645 (for example, the codepoint mapping to 0≥ΔL1-CLI-RSSI>−2 dB). In some other aspects, one of the codepoints shown in FIG. 6C may be redefined as an out-of-range indicator (for example, to indicate that the ΔL1-SRS-RSRP>0 dB or ΔL1-CLI-RSSI>0 dB). For example, a first-in-position codepoint in an L1 CLI differential codebook (for example, L1 CLI differential codebook 640, 645) or else a last-in-position codepoint in the L1 CLI differential codebook may be redefined to indicate an out-of-range measurement result (for example, to indicate that the measurement result is greater than 0 dB from a reference measurement result).

Additionally or alternatively, in some aspects, any measurement results that are not a most interfered measurement result and that are within a measurement range (for example, within the range [−140, −44] dBm for L1-SRS-RSRP measurements or within the range [−100, −25] dBm for L1-CLI-RSSI measurements) may be reported as a differential value with respect to a largest value in the measurement range (for example, −44 dBm for L1-SRS-RSRP or −25 dBm for L1-CLI-RSSI). For example, each measurement result that is not a most interfered measurement result and that is within a measurement range may be reported with a 4-bit codepoint that maps to one of the values described above in connection with the L1 CLI differential codebooks 640, 645, among other examples.

To summarize, if the number of reported L1/SRS-RSRP measurement resources or L1-CLI-RSSI measurement resources is M, and the number of reported L1/SRS-RSRP measurement results or L1-CLI-RSSI measurement results which are out of range is X (with X≤M), the measurement report may include an out-of-range indicator for the most interfered (for example, largest) measurement result (which, in some aspects, may be 7 bits), out-of-range indicators for each of the X-1 measurement results that are out of range but are not the most interfered measurement result (which, in some aspects, may be 4 bits each, for a total of (X−1)×4 bits), and codepoints mapping to differential values with respect to a largest value in a measurement range (for example, using −44 dBm as the reference for L1-SRS-RSRP or using −25 dBm as the reference for L1-CLI-RSSI) for the M-X measurement results that are within the reporting range (which, in some aspects, may be 4 bits each, for a total of (M−X)×4 bits).

In some aspects, in order to reduce overhead associated with the measurement report, one or more measurement result may be reported as a differential value with respect to a next highest measurement result rather than to a single reference measurement. For example, in a similar manner as described above, an absolute value of the most interfered (largest) measured L1-CLI-RSSI or L1-SRS-RSRP may be reported, such as by using 7 bits. In this aspect, however, when the number of reported CLI measurement resources is larger than one, (for example, when M>1) a differential reporting method is used that takes the most interfered measured L1-CLI-RSSI or L1-SRS-RSRP as the reference for the second reported measurement result (for example, the second most interfered measured L1-CLI-RSSI or L1-SRS-RSRP), that takes the second most interfered measured L1-CLI-RSSI or L1-SRS-RSRP as the reference for the third reported measurement result (for example, the third most interfered measured L1-CLI-RSSI or L1-SRS-RSRP), and that takes third most interfered measured L1-CLI-RSSI or L1-SRS-RSRP as the reference for the fourth reported measurement result (for example, the third most interfered measured L1-CLI-RSSI or L1-SRS-RSRP). Put another way, in some aspects, the measurement report may indicate a first measurement result for a first CLI measurement resource (for example, by reporting an absolute measurement result), a second measurement result for a second CLI measurement resource by indicating a first difference between the first measurement result and the second measurement result, a third measurement result for a third CLI measurement resource by indicating a second difference between the second measurement result and the third measurement result, a fourth measurement result for a fourth CLI measurement resource by indicating a third difference between the third measurement result and the fourth measurement result, and so forth.

In such aspects, signaling overhead may be reduced because fewer bits may be needed to report the differential measurement results in the measurement report. More particularly, as described above in connection with FIGS. 6B and 6C, in some examples four bits may be used for the differential reported CLI resources with 2 dB step size and up to 32 dB of differential range. However, in aspects in which each differential measurement result is reported with respect to a next highest interfered measurement result, a smaller differential range may be necessary and thus less bits may be used to report the differential values. Put another, in such aspects, a range for a differential codebook (for example, L1 CLI differential codebook 640, 645) may be reduced and thus the reported bits may be reduced as well (for example instead of 4 bits of 32 dB differential reporting range, the differential measurement results may be reported using 2 or 3 bits for each measurement resource in the report).

As indicated above, FIGS. 6A-6C are provided as an example. Other examples may differ from what is described with respect to FIGS. 6A-6C.

FIG. 7 is a flowchart illustrating an example process 700 performed, for example, at a UE or an apparatus of a UE that supports measurement resource configuration and reporting. Example process 700 is an example where the apparatus or the UE (for example, UE 120) performs operations associated with L1 CLI measurement resource configuration and reporting.

As shown in FIG. 7, in some aspects, process 700 may include receiving configuration information configuring a first quantity of L1 CLI measurement resources (block 710). For example, the UE (such as by using communication manager 150 or reception component 1502, depicted in FIG. 15) may receive configuration information configuring a first quantity of L1 CLI measurement resources, as described above.

As further shown in FIG. 7, in some aspects, process 700 may include transmitting a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range (block 720). For example, the UE (such as by using communication manager 150 or transmission component 1504, depicted in FIG. 15) may transmit a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range, as described above.

Process 700 may include additional aspects, such as any single aspect or any combination of aspects described below or in connection with one or more other processes described elsewhere herein.

In a first additional aspect, the second quantity is less than or equal to the first quantity.

In a second additional aspect, alone or in combination with the first aspect, one of the L1 CLI measurement resources are L1-SRS-RSRP resources and the measurement range is −140 dBm to −44 dBm, or the L1 CLI measurement resources are L1-CLI-RSSI resources and the measurement range is −100 dBm to −25 dBm.

In a third additional aspect, alone or in combination with one or more of the first and second aspects, the measurement report indicates a second measurement result for a second CLI measurement resource, of the second quantity of CLI measurement resources, by indicating one of a second codepoint that maps to an out-of-range value in an L1 CLI differential codebook in accordance with the second measurement result being larger than the largest value of the measurement range, or a third codepoint that maps to a value in the L1 CLI differential codebook corresponding to a difference between the largest value of the measurement range and the second measurement result.

In a fourth additional aspect, alone or in combination with one or more of the first through third aspects, the second codepoint that maps to the out-of-range value in the L1 CLI differential codebook is one of a first-in-position codepoint in the L1 CLI differential codebook, a last-in-position codepoint in the L1 CLI differential codebook, or an out-of-range codepoint in the L1 CLI differential codebook.

In a fifth additional aspect, alone or in combination with one or more of the first through fourth aspects, the measurement report indicates a second measurement result for a second CLI measurement resource, of the second quantity of CLI measurement resources, by indicating a second codepoint that maps to a first value in an L1 CLI differential codebook corresponding to a first difference between the largest value of the measurement range and the second measurement result, and a third measurement result for a third CLI measurement resource, of the second quantity of CLI measurement resources, by indicating a third codepoint that maps to a second value in the L1 CLI differential codebook corresponding to a second difference between the second measurement result and the third measurement result.

In a sixth additional aspect, alone or in combination with one or more of the first through fifth aspects, the configuration information configures at least one of a quantity of bits for a codepoint used to report measurement results in the measurement report, the measurement range, a codebook resolution used to report the measurement results in the measurement report, or one or more events that trigger the measurement report.

In a seventh additional aspect, alone or in combination with one or more of the first through sixth aspects, receiving the configuration information that configures the at least one of the quantity of bits for the codepoint, the measurement range, the codebook resolution, or the one or more events includes receiving the configuration information via at least one of a measurement report configuration IE, a measurement resource configuration IE, or dedicated radio resource control signaling for indicating the at least one of the quantity of bits for the codepoint, the codebook resolution, or the one or more events.

In an eighth additional aspect, alone or in combination with one or more of the first through seventh aspects, process 700 includes detecting that the configuration information omits one or more indications corresponding to one or more of the quantity of bits for the codepoint, the measurement range, the codebook resolution, or the one or more events, wherein transmitting the measurement report is in accordance with one or more of a default quantity of bits for the codepoint, a default measurement range, a default codebook resolution, or a default set of events in response to detecting that the configuration information omits the one or more indications.

In a ninth additional aspect, alone or in combination with one or more of the first through eighth aspects, the first quantity of L1 CLI measurement resources include at least one periodic CLI measurement resource having a first QCL assumption for type D, wherein the process 700 further comprises receiving a MAC-CE updating the first QCL assumption to a second QCL assumption, measuring the at least one periodic CLI measurement resource in accordance with the second QCL assumption, and transmitting the measurement report in accordance with the second QCL assumption.

In a tenth additional aspect, alone or in combination with one or more of the first through ninth aspects, the at least one periodic CLI measurement resource is one of a periodic SRS-RSRP resource, or a periodic CLI-RSSI resource.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a UE or an apparatus of a UE that supports measurement resource configuration and reporting. Example process 800 is an example where the apparatus or the UE (for example, UE 120) performs operations associated with differential CLI measurement resource reporting.

As shown in FIG. 8, in some aspects, process 800 may include receiving configuration information configuring a first quantity of L1 CLI measurement resources (block 810). For example, the UE (such as by using communication manager 150 or reception component 1602, depicted in FIG. 16) may receive configuration information configuring a first quantity of L1 CLI measurement resources, as described above.

As further shown in FIG. 8, in some aspects, process 800 may include transmitting a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result (block 820). For example, the UE (such as by using communication manager 150 or transmission component 1604, depicted in FIG. 16) may transmit a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result, as described above.

Process 800 may include additional aspects, such as any single aspect or any combination of aspects described below or in connection with one or more other processes described elsewhere herein.

In a first additional aspect, the measurement report indicates the first measurement result by indicating one of a largest value of a measurement range in an L1 CLI absolute codebook in accordance with the first measurement result being larger than the largest value of the measurement range, or a value within the measurement range in accordance with the first measurement result being less than or equal to the largest value of the measurement range.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, at a UE or an apparatus of a UE that supports measurement resource configuration and reporting. Example process 900 is an example where the apparatus or the UE (for example, UE 120) performs operations associated with configuration parameters for a measurement report.

As shown in FIG. 9, in some aspects, process 900 may include receiving configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report (block 910). For example, the UE (such as by using communication manager 150 or reception component 1702, depicted in FIG. 17) may receive configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report, as described above.

As further shown in FIG. 9, in some aspects, process 900 may include transmitting the measurement report in accordance with the configuration information (block 920). For example, the UE (such as by using communication manager 150 or transmission component 1704, depicted in FIG. 17) may transmit the measurement report in accordance with the configuration information, as described above.

Process 900 may include additional aspects, such as any single aspect or any combination of aspects described below or in connection with one or more other processes described elsewhere herein.

In a first additional aspect, the measurement report is one of an L3-CLI-RSSI report, or an L3-SRS-RSRP report.

In a second additional aspect, alone or in combination with the first aspect, the measurement report is one of an L1-CLI-RSSI report, an L1-SRS-RSRP report, an L1-RSRP report, or an L1-SINR report.

In a third additional aspect, alone or in combination with one or more of the first and second aspects, receiving the configuration information includes receiving the configuration information via at least one of a measurement report configuration IE, a measurement resource configuration IE, or dedicated radio resource control signaling for indicating the at least one of the quantity of bits for the codepoint, the codebook resolution, or the one or more events.

In a fourth additional aspect, alone or in combination with one or more of the first through third aspects, process 900 includes detecting that the configuration information omits one or more indications corresponding to one or more of the quantity of bits for the codepoint, the measurement range, the codebook resolution, or the one or more events, wherein transmitting the measurement report is in accordance with one or more of a default quantity of bits for the codepoint, a default measurement range, a default codebook resolution, or a default set of events in response to detecting that the configuration information omits the one or more indications.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a UE or an apparatus of a UE that supports measurement resource configuration and reporting. Example process 1000 is an example where the apparatus or the UE (for example, UE 120) performs operations associated with MAC-CE updates for QCL assumptions.

As shown in FIG. 10, in some aspects, process 1000 may include receiving configuration information configuring a periodic CLI measurement resource and a first QCL assumption for type D for the periodic CLI measurement resource (block 1010). For example, the UE (such as by using communication manager 150 or reception component 1802, depicted in FIG. 18) may receive configuration information configuring a periodic CLI measurement resource and a first QCL assumption for type D for the periodic CLI measurement resource, as described above.

As further shown in FIG. 10, in some aspects, process 1000 may include receiving a MAC-CE updating the first QCL assumption to a second QCL assumption (block 1020). For example, the UE (such as by using communication manager 150 or reception component 1802, depicted in FIG. 18) may receive a MAC-CE updating the first QCL assumption to a second QCL assumption, as described above.

As further shown in FIG. 10, in some aspects, process 1000 may include measuring the periodic CLI measurement resource in accordance with the second QCL assumption (block 1030). For example, the UE (such as by using communication manager 150 or reporting component 1810, depicted in FIG. 18) may measure the periodic CLI measurement resource in accordance with the second QCL assumption, as described above.

As further shown in FIG. 10, in some aspects, process 1000 may include transmitting a measurement report in accordance with the configuration information and the second QCL assumption (block 1040). For example, the UE (such as by using communication manager 150 or transmission component 1804, depicted in FIG. 18) may transmit a measurement report in accordance with the configuration information and the second QCL assumption, as described above.

Process 1000 may include additional aspects, such as any single aspect or any combination of aspects described below or in connection with one or more other processes described elsewhere herein.

In a first additional aspect, the periodic CLI measurement resource is one of a periodic SRS-RSRP resource, or a periodic CLI-RSSI resource.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a network node or an apparatus of a network node that supports measurement resource configuration and reporting. Example process 1100 is an example where the apparatus or the network node (for example, network node 110) performs operations associated with L1 CLI measurement resource configuration and reporting.

As shown in FIG. 11, in some aspects, process 1100 may include transmitting, to a UE, configuration information configuring a first quantity of L1 CLI measurement resources (block 1110). For example, the network node (such as by using communication manager 150 or transmission component 1904, depicted in FIG. 19) may transmit, to a UE, configuration information configuring a first quantity of L1 CLI measurement resources, as described above.

As further shown in FIG. 11, in some aspects, process 1100 may include receiving, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range (block 1120). For example, the network node (such as by using communication manager 150 or reception component 1902, depicted in FIG. 19) may receive, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range, as described above.

Process 1100 may include additional aspects, such as any single aspect or any combination of aspects described below or in connection with one or more other processes described elsewhere herein.

In a first additional aspect, the second quantity is less than or equal to the first quantity.

In a second additional aspect, alone or in combination with the first aspect, one of the L1 CLI measurement resources are L1-SRS-RSRP resources and the measurement range is −140 decibel-milliwatts (dBm) to −44 dBm, or the L1 CLI measurement resources are L1-CLI-RSSI resources and the measurement range is −100 dBm to −25 dBm.

In a third additional aspect, alone or in combination with one or more of the first and second aspects, the measurement report indicates a second measurement result for a second CLI measurement resource, of the second quantity of CLI measurement resources, by indicating one of a second codepoint that maps to an out-of-range value in an L1 CLI differential codebook in accordance with the second measurement result being larger than the largest value of the measurement range, or a third codepoint that maps to a value in the L1 CLI differential codebook corresponding to a difference between the largest value of the measurement range and the second measurement result.

In a fourth additional aspect, alone or in combination with one or more of the first through third aspects, the second codepoint that maps to the out-of-range value in the L1 CLI differential codebook is one of a first-in-position codepoint in the L1 CLI differential codebook, a last-in-position codepoint in the L1 CLI differential codebook, or an out-of-range codepoint in the L1 CLI differential codebook.

In a fifth additional aspect, alone or in combination with one or more of the first through fourth aspects, the measurement report indicates a second measurement result for a second CLI measurement resource, of the second quantity of CLI measurement resources, by indicating a second codepoint that maps to a first value in an L1 CLI differential codebook corresponding to a first difference between the largest value of the measurement range and the second measurement result, and a third measurement result for a third CLI measurement resource, of the second quantity of CLI measurement resources, by indicating a third codepoint that maps to a second value in the L1 CLI differential codebook corresponding to a second difference between the second measurement result and the third measurement result.

In a sixth additional aspect, alone or in combination with one or more of the first through fifth aspects, the configuration information configures at least one of a quantity of bits for a codepoint used to report measurement results in the measurement report, the measurement range, a codebook resolution used to report the measurement results in the measurement report, or one or more events that trigger the measurement report.

In a seventh additional aspect, alone or in combination with one or more of the first through sixth aspects, transmitting the configuration information that configures the at least one of the quantity of bits for the codepoint, the measurement range, the codebook resolution, or the one or more events includes transmitting the configuration information via at least one of a measurement report configuration IE, a measurement resource configuration IE, or dedicated radio resource control signaling for indicating the at least one of the quantity of bits for the codepoint, the codebook resolution, or the one or more events.

In an eighth additional aspect, alone or in combination with one or more of the first through seventh aspects, the configuration information omits one or more indications corresponding to one or more of the quantity of bits for the codepoint, the measurement range, the codebook resolution, or the one or more events, and wherein the measurement report is in accordance with one or more of a default quantity of bits for the codepoint, a default measurement range, a default codebook resolution, or a default set of events in response to the configuration information omitting the one or more indications.

In a ninth additional aspect, alone or in combination with one or more of the first through eighth aspects, the first quantity of L1 CLI measurement resources include at least one periodic CLI measurement resource having a first QCL assumption for type D, wherein the process 1100 further comprises transmitting, to the UE, a MAC-CE updating the first QCL assumption to a second QCL assumption, and wherein the measurement report is in accordance with the second QCL assumption.

In a tenth additional aspect, alone or in combination with one or more of the first through ninth aspects, the at least one periodic CLI measurement resource is one of a periodic SRS-RSRP resource, or a periodic CLI-RSSI resource.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, at a network node or an apparatus of a network node that supports measurement resource configuration and reporting. Example process 1200 is an example where the apparatus or the network node (for example, network node 110) performs operations associated with differential CLI measurement resource reporting.

As shown in FIG. 12, in some aspects, process 1200 may include transmitting, to a UE, configuration information configuring a first quantity of L1 CLI measurement resources (block 1210). For example, the network node (such as by using communication manager 150 or transmission component 2004, depicted in FIG. 20) may transmit, to a UE, configuration information configuring a first quantity of L1 CLI measurement resources, as described above.

As further shown in FIG. 12, in some aspects, process 1200 may include receiving, from the UE, a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result (block 1220). For example, the network node (such as by using communication manager 150 or reception component 2002, depicted in FIG. 20) may receive, from the UE, a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result, as described above.

Process 1200 may include additional aspects, such as any single aspect or any combination of aspects described below or in connection with one or more other processes described elsewhere herein.

In a first additional aspect, the measurement report indicates the first measurement result by indicating one of a largest value of a measurement range in an L1 CLI absolute codebook in accordance with the first measurement result being larger than the largest value of the measurement range, or a value within the measurement range in accordance with the first measurement result being less than or equal to the largest value of the measurement range.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a flowchart illustrating an example process 1300 performed, for example, at a network node or an apparatus of a network node that supports measurement resource configuration and reporting. Example process 1300 is an example where the apparatus or the network node (for example, network node 110) performs operations associated with configuration parameters for a measurement report.

As shown in FIG. 13, in some aspects, process 1300 may include transmitting, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report (block 1310). For example, the network node (such as by using communication manager 150 or transmission component 2104, depicted in FIG. 21) may transmit, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report, as described above.

As further shown in FIG. 13, in some aspects, process 1300 may include receiving, from the UE, the measurement report in accordance with the configuration information (block 1320). For example, the network node (such as by using communication manager 150 or reception component 2102, depicted in FIG. 21) may receive, from the UE, the measurement report in accordance with the configuration information, as described above.

Process 1300 may include additional aspects, such as any single aspect or any combination of aspects described below or in connection with one or more other processes described elsewhere herein.

In a first additional aspect, the measurement report is one of an L3-CLI-RSSI report, or an L3-SRS-RSRP report.

In a second additional aspect, alone or in combination with the first aspect, the measurement report is one of an L1-CLI-RSSI report, an L1-SRS-RSRP report, an L1-RSRP report, or an L1-SINR report.

In a third additional aspect, alone or in combination with one or more of the first and second aspects, transmitting the configuration information includes transmitting the configuration information via at least one of a measurement report configuration IE, a measurement resource configuration IE, or dedicated radio resource control signaling for indicating the at least one of the quantity of bits for the codepoint, the codebook resolution, or the one or more events.

In a fourth additional aspect, alone or in combination with one or more of the first through third aspects, the configuration information omits one or more indications corresponding to one or more of the quantity of bits for the codepoint, the measurement range, the codebook resolution, or the one or more events, and wherein the measurement report is in accordance with one or more of a default quantity of bits for the codepoint, a default measurement range, a default codebook resolution, or a default set of events in response to the configuration information omitting the one or more indications.

Although FIG. 13 shows example blocks of process 1300, in some aspects, process 1300 may include additional blocks, fewer blocks, different blocks, or differently arranged blocks than those depicted in FIG. 13. Additionally or alternatively, two or more of the blocks of process 1300 may be performed in parallel.

FIG. 14 is a flowchart illustrating an example process 1400 performed, for example, at a network node or an apparatus of a network node that supports measurement resource configuration and reporting. Example process 1400 is an example where the apparatus or the network node (for example, network node 110) performs operations associated with MAC-CE updates for QCL assumptions.

As shown in FIG. 14, in some aspects, process 1400 may include transmitting, to a UE, configuration information configuring a periodic CLI measurement resource and a first QCL assumption for type D for the periodic CLI measurement resource (block 1410). For example, the network node (such as by using communication manager 150 or transmission component 2204, depicted in FIG. 22) may transmit, to a UE, configuration information configuring a periodic CLI measurement resource and a first QCL assumption for type D for the periodic CLI measurement resource, as described above.

As further shown in FIG. 14, in some aspects, process 1400 may include transmitting, to the UE, a MAC-CE updating the first QCL assumption to a second QCL assumption (block 1420). For example, the network node (such as by using communication manager 150 or transmission component 2204, depicted in FIG. 22) may transmit, to the UE, a MAC-CE updating the first QCL assumption to a second QCL assumption, as described above.

As further shown in FIG. 14, in some aspects, process 1400 may include receiving, from the UE, a measurement report in accordance with the configuration information and the second QCL assumption (block 1430). For example, the network node (such as by using communication manager 150 or reception component 2202, depicted in FIG. 22) may receive, from the UE, a measurement report in accordance with the configuration information and the second QCL assumption, as described above.

Process 1400 may include additional aspects, such as any single aspect or any combination of aspects described below or in connection with one or more other processes described elsewhere herein.

In a first additional aspect, the periodic CLI measurement resource is one of a periodic SRS-RSRP resource, or a periodic CLI-RSSI resource.

Although FIG. 14 shows example blocks of process 1400, in some aspects, process 1400 may include additional blocks, fewer blocks, different blocks, or differently arranged blocks than those depicted in FIG. 14. Additionally or alternatively, two or more of the blocks of process 1400 may be performed in parallel.

FIG. 15 is a diagram of an example apparatus 1500 for wireless communication that supports measurement resource configuration and reporting. The apparatus 1500 may be a UE, or a UE may include the apparatus 1500. In some aspects, the apparatus 1500 includes a reception component 1502, a transmission component 1504, and a communication manager 1506, which may be in communication with one another (for example, via one or more buses). As shown, the apparatus 1500 may communicate with another apparatus 1508 (such as a UE 120, a network node 110, or another wireless communication device) using the reception component 1502 and the transmission component 1504. The communication manager 1506 may be included in, or implemented via, a processing system (for example, the processing system 140). In some aspects, the communication manager 1506 is the communication manager 150.

In some aspects, the apparatus 1500 may be configured to or operable to perform one or more operations described herein in connection with FIGS. 6A-6C. Additionally or alternatively, the apparatus 1500 may be configured to or operable to perform one or more processes described herein, such as process 700 of FIG. 7.

The reception component 1502 may receive communications, such as reference signals, control information, or data communications, from the apparatus 1508. The reception component 1502 may provide received communications to one or more other components of the apparatus 1500, such as the communication manager 1506. In some aspects, the reception component 1502 may perform signal processing on the received communications, and may provide the processed signals to the one or more other components in a similar manner as described above in connection with FIG. 1. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, or data communications, to the apparatus 1508. In some aspects, the communication manager 1506 may generate communications and may transmit the generated communications to the transmission component 1504 for transmission to the apparatus 1508. In some aspects, the transmission component 1504 may perform signal processing on the generated communications, and may transmit the processed signals to the apparatus 1508 in a similar manner as described above in connection with FIG. 1. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE. In some aspects, the transmission component 1504 may be co-located with the reception component 1502.

The communication manager 1506 may receive or may cause the reception component 1502 to receive configuration information configuring a first quantity of L1 CLI measurement resources. The communication manager 1506 may transmit or may cause the transmission component 1504 to transmit a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range. In some aspects, the communication manager 1506 may perform one or more operations described elsewhere herein as being performed by one or more components of the communication manager 1506.

In some aspects, the communication manager 1506 includes a set of components, such as a reporting component 1510. Alternatively, the set of components may be separate and distinct from the communication manager 1506. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1502 may receive configuration information configuring a first quantity of L1 CLI measurement resources. The transmission component 1504 or reporting component 1510 may transmit a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

The reporting component 1510 may detect that the configuration information omits one or more indications corresponding to one or more of the quantity of bits for the codepoint, the measurement range, the codebook resolution, or the one or more events wherein transmitting the measurement report is in accordance with one or more of a default quantity of bits for the codepoint, a default measurement range, a default codebook resolution, or a default set of events in response to detecting that the configuration information omits the one or more indications.

The quantity and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

FIG. 16 is a diagram of an example apparatus 1600 for wireless communication that supports measurement resource configuration and reporting. The apparatus 1600 may be a UE, or a UE may include the apparatus 1600. In some aspects, the apparatus 1600 includes a reception component 1602, a transmission component 1604, and a communication manager 1606, which may be in communication with one another (for example, via one or more buses). As shown, the apparatus 1600 may communicate with another apparatus 1608 (such as a UE 120, a network node 110, or another wireless communication device) using the reception component 1602 and the transmission component 1604. The communication manager 1606 may be included in, or implemented via, a processing system (for example, the processing system 140). In some aspects, the communication manager 1606 is the communication manager 150.

In some aspects, the apparatus 1600 may be configured to or operable to perform one or more operations described herein in connection with FIGS. 6A-6C. Additionally or alternatively, the apparatus 1600 may be configured to or operable to perform one or more processes described herein, such as process 800 of FIG. 8.

The reception component 1602 may receive communications, such as reference signals, control information, or data communications, from the apparatus 1608. The reception component 1602 may provide received communications to one or more other components of the apparatus 1600, such as the communication manager 1606. In some aspects, the reception component 1602 may perform signal processing on the received communications, and may provide the processed signals to the one or more other components in a similar manner as described above in connection with FIG. 1. In some aspects, the reception component 1602 may include one or more components of the UE described above in connection with FIG. 1, such as a radio, one or more RF chains, one or more transceivers, or one or more modems, each of which may in turn be coupled with one or more antennas of the UE.

The transmission component 1604 may transmit communications, such as reference signals, control information, or data communications, to the apparatus 1608. In some aspects, the communication manager 1606 may generate communications and may transmit the generated communications to the transmission component 1604 for transmission to the apparatus 1608. In some aspects, the transmission component 1604 may perform signal processing on the generated communications, and may transmit the processed signals to the apparatus 1608 in a similar manner as described above in connection with FIG. 1. In some aspects, the transmission component 1604 may include one or more components of the UE described above in connection with FIG. 1, such as a radio, one or more RF chains, one or more transceivers, or one or more modems, each of which may in turn be coupled with one or more antennas of the UE. In some aspects, the transmission component 1604 may be co-located with the reception component 1602.

The communication manager 1606 may receive or may cause the reception component 1602 to receive configuration information configuring a first quantity of L1 CLI measurement resources. The communication manager 1606 may transmit or may cause the transmission component 1604 to transmit a measurement report for a second quantity of the L1 CLI measurement resources that indicates a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result. In some aspects, the communication manager 1606 may perform one or more operations described elsewhere herein as being performed by one or more components of the communication manager 1606.

In some aspects, the communication manager 1606 includes a set of components, such as a reporting component 1610. Alternatively, the set of components may be separate and distinct from the communication manager 1606. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1602 may receive configuration information configuring a first quantity of L1 CLI measurement resources. The transmission component 1604 or reporting component 1610 may transmit a measurement report for a second quantity of the L1 CLI measurement resources that indicates a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.

The quantity and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally or alternatively, a set of (one or more) components shown in FIG. 16 may perform one or more functions described as being performed by another set of components shown in FIG. 16.

FIG. 17 is a diagram of an example apparatus 1700 for wireless communication that supports measurement resource configuration and reporting. The apparatus 1700 may be a UE, or a UE may include the apparatus 1700. In some aspects, the apparatus 1700 includes a reception component 1702, a transmission component 1704, and a communication manager 1706, which may be in communication with one another (for example, via one or more buses). As shown, the apparatus 1700 may communicate with another apparatus 1708 (such as a UE 120, a network node 110, or another wireless communication device) using the reception component 1702 and the transmission component 1704. The communication manager 1706 may be included in, or implemented via, a processing system (for example, the processing system 140). In some aspects, the communication manager 1706 is the communication manager 150.

In some aspects, the apparatus 1700 may be configured to or operable to perform one or more operations described herein in connection with FIGS. 6A-6C. Additionally or alternatively, the apparatus 1700 may be configured to or operable to perform one or more processes described herein, such as process 900 of FIG. 9.

The reception component 1702 may receive communications, such as reference signals, control information, or data communications, from the apparatus 1708. The reception component 1702 may provide received communications to one or more other components of the apparatus 1700, such as the communication manager 1706. In some aspects, the reception component 1702 may perform signal processing on the received communications, and may provide the processed signals to the one or more other components in a similar manner as described above in connection with FIG. 1. In some aspects, the reception component 1702 may include one or more components of the UE described above in connection with FIG. 1, such as a radio, one or more RF chains, one or more transceivers, or one or more modems, each of which may in turn be coupled with one or more antennas of the UE.

The transmission component 1704 may transmit communications, such as reference signals, control information, or data communications, to the apparatus 1708. In some aspects, the communication manager 1706 may generate communications and may transmit the generated communications to the transmission component 1704 for transmission to the apparatus 1708. In some aspects, the transmission component 1704 may perform signal processing on the generated communications, and may transmit the processed signals to the apparatus 1708 in a similar manner as described above in connection with FIG. 1. In some aspects, the transmission component 1704 may include one or more components of the UE described above in connection with FIG. 1, such as a radio, one or more RF chains, one or more transceivers, or one or more modems, each of which may in turn be coupled with one or more antennas of the UE. In some aspects, the transmission component 1704 may be co-located with the reception component 1702.

The communication manager 1706 may receive or may cause the reception component 1702 to receive configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The communication manager 1706 may transmit or may cause the transmission component 1704 to transmit the measurement report in accordance with the configuration information. In some aspects, the communication manager 1706 may perform one or more operations described elsewhere herein as being performed by one or more components of the communication manager 1706.

In some aspects, the communication manager 1706 includes a set of components, such as a reporting component 1710. Alternatively, the set of components may be separate and distinct from the communication manager 1706. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1702 may receive configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The transmission component 1704 or the reporting component 1710 may transmit the measurement report in accordance with the configuration information.

The reporting component 1710 may detect that the configuration information omits one or more indications corresponding to one or more of the quantity of bits for the codepoint, the measurement range, the codebook resolution, or the one or more events wherein transmitting the measurement report is in accordance with one or more of a default quantity of bits for the codepoint, a default measurement range, a default codebook resolution, or a default set of events in response to detecting that the configuration information omits the one or more indications.

The quantity and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally or alternatively, a set of (one or more) components shown in FIG. 17 may perform one or more functions described as being performed by another set of components shown in FIG. 17.

FIG. 18 is a diagram of an example apparatus 1800 for wireless communication that supports measurement resource configuration and reporting. The apparatus 1800 may be a UE, or a UE may include the apparatus 1800. In some aspects, the apparatus 1800 includes a reception component 1802, a transmission component 1804, and a communication manager 1806, which may be in communication with one another (for example, via one or more buses). As shown, the apparatus 1800 may communicate with another apparatus 1808 (such as a UE 120, a network node 110, or another wireless communication device) using the reception component 1802 and the transmission component 1804. The communication manager 1806 may be included in, or implemented via, a processing system (for example, the processing system 140). In some aspects, the communication manager 1806 is the communication manager 150.

In some aspects, the apparatus 1800 may be configured to or operable to perform one or more operations described herein in connection with FIGS. 6A-6C. Additionally or alternatively, the apparatus 1800 may be configured to or operable to perform one or more processes described herein, such as process 1000 of FIG. 10.

The reception component 1802 may receive communications, such as reference signals, control information, or data communications, from the apparatus 1808. The reception component 1802 may provide received communications to one or more other components of the apparatus 1800, such as the communication manager 1806. In some aspects, the reception component 1802 may perform signal processing on the received communications, and may provide the processed signals to the one or more other components in a similar manner as described above in connection with FIG. 1. In some aspects, the reception component 1802 may include one or more components of the UE described above in connection with FIG. 1, such as a radio, one or more RF chains, one or more transceivers, or one or more modems, each of which may in turn be coupled with one or more antennas of the UE.

The transmission component 1804 may transmit communications, such as reference signals, control information, or data communications, to the apparatus 1808. In some aspects, the communication manager 1806 may generate communications and may transmit the generated communications to the transmission component 1804 for transmission to the apparatus 1808. In some aspects, the transmission component 1804 may perform signal processing on the generated communications, and may transmit the processed signals to the apparatus 1808 in a similar manner as described above in connection with FIG. 1. In some aspects, the transmission component 1804 may include one or more components of the UE described above in connection with FIG. 1, such as a radio, one or more RF chains, one or more transceivers, or one or more modems, each of which may in turn be coupled with one or more antennas of the UE. In some aspects, the transmission component 1804 may be co-located with the reception component 1802.

The communication manager 1806 may receive or may cause the reception component 1802 to receive configuration information configuring a periodic CLI measurement resource and a first QCL assumption for type D for the periodic CLI measurement resource. The communication manager 1806 may receive or may cause the reception component 1802 to receive a MAC-CE updating the first QCL assumption to a second QCL assumption. The communication manager 1806 may measure the periodic CLI measurement resource in accordance with the second QCL assumption. The communication manager 1806 may transmit or may cause the transmission component 1804 to transmit a measurement report in accordance with the configuration information and the second QCL assumption. In some aspects, the communication manager 1806 may perform one or more operations described elsewhere herein as being performed by one or more components of the communication manager 1806.

In some aspects, the communication manager 1806 includes a set of components, such as a reporting component 1810. Alternatively, the set of components may be separate and distinct from the communication manager 1806. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1802 may receive configuration information configuring a periodic CLI measurement resource and a first QCL assumption for type D for the periodic CLI measurement resource. The reception component 1802 may receive a MAC-CE updating the first QCL assumption to a second QCL assumption. The reporting component 1810 may measure the periodic CLI measurement resource in accordance with the second QCL assumption. The transmission component 1804 or the reporting component 1810 may transmit a measurement report in accordance with the configuration information and the second QCL assumption.

The quantity and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally or alternatively, a set of (one or more) components shown in FIG. 18 may perform one or more functions described as being performed by another set of components shown in FIG. 18.

FIG. 19 is a diagram of an example apparatus 1900 for wireless communication that supports measurement resource configuration and reporting. The apparatus 1900 may be a network node, or a network node may include the apparatus 1900. In some aspects, the apparatus 1900 includes a reception component 1902, a transmission component 1904, and a communication manager 1906, which may be in communication with one another (for example, via one or more buses). As shown, the apparatus 1900 may communicate with another apparatus 1908 (such as a UE 120, a network node 110, or another wireless communication device) using the reception component 1902 and the transmission component 1904. The communication manager 1906 may be included in, or implemented via, a processing system (for example, the processing system 145). In some aspects, the communication manager 1906 is the communication manager 155.

In some aspects, the apparatus 1900 may be configured to or operable to perform one or more operations described herein in connection with FIGS. 6A-6C. Additionally or alternatively, the apparatus 1900 may be configured to or operable to perform one or more processes described herein, such as process 1100 of FIG. 11.

The reception component 1902 may receive communications, such as reference signals, control information, or data communications, from the apparatus 1908. The reception component 1902 may provide received communications to one or more other components of the apparatus 1900, such as the communication manager 1906. In some aspects, the reception component 1902 may perform signal processing on the received communications, and may provide the processed signals to the one or more other components in a similar manner as described above in connection with FIG. 1. In some aspects, the reception component 1902 may include one or more components of the network node described above in connection with FIG. 1, such as a radio, one or more RF chains, one or more transceivers, or one or more modems, each of which may in turn be coupled with one or more antennas of the network node.

The transmission component 1904 may transmit communications, such as reference signals, control information, or data communications, to the apparatus 1908. In some aspects, the communication manager 1906 may generate communications and may transmit the generated communications to the transmission component 1904 for transmission to the apparatus 1908. In some aspects, the transmission component 1904 may perform signal processing on the generated communications, and may transmit the processed signals to the apparatus 1908 in a similar manner as described above in connection with FIG. 1. In some aspects, the transmission component 1904 may include one or more components of the network node described above in connection with FIG. 1, such as a radio, one or more RF chains, one or more transceivers, or one or more modems, each of which may in turn be coupled with one or more antennas of the network node. In some aspects, the transmission component 1904 may be co-located with the reception component 1902.

The communication manager 1906 may transmit or may cause the transmission component 1904 to transmit, to a UE, configuration information configuring a first quantity of L1 CLI measurement resources. The communication manager 1906 may receive or may cause the reception component 1902 to receive, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range. In some aspects, the communication manager 1906 may perform one or more operations described elsewhere herein as being performed by one or more components of the communication manager 1906.

In some aspects, the communication manager 1906 includes a set of components, such as a configuration component 1910. Alternatively, the set of components may be separate and distinct from the communication manager 1906. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1904 or configuration component 1910 may transmit, to a UE, configuration information configuring a first quantity of L1 CLI measurement resources. The reception component 1902 may receive, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

The quantity and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally or alternatively, a set of (one or more) components shown in FIG. 19 may perform one or more functions described as being performed by another set of components shown in FIG. 19.

FIG. 20 is a diagram of an example apparatus 2000 for wireless communication that supports measurement resource configuration and reporting. The apparatus 2000 may be a network node, or a network node may include the apparatus 2000. In some aspects, the apparatus 2000 includes a reception component 2002, a transmission component 2004, and a communication manager 2006, which may be in communication with one another (for example, via one or more buses). As shown, the apparatus 2000 may communicate with another apparatus 2008 (such as a UE 120, a network node 110, or another wireless communication device) using the reception component 2002 and the transmission component 2004. The communication manager 2006 may be included in, or implemented via, a processing system (for example, the processing system 145). In some aspects, the communication manager 2006 is the communication manager 155.

In some aspects, the apparatus 2000 may be configured to or operable to perform one or more operations described herein in connection with FIGS. 6A-6C. Additionally or alternatively, the apparatus 2000 may be configured to or operable to perform one or more processes described herein, such as process 1200 of FIG. 12.

The reception component 2002 may receive communications, such as reference signals, control information, or data communications, from the apparatus 2008. The reception component 2002 may provide received communications to one or more other components of the apparatus 2000, such as the communication manager 2006. In some aspects, the reception component 2002 may perform signal processing on the received communications, and may provide the processed signals to the one or more other components in a similar manner as described above in connection with FIG. 1. In some aspects, the reception component 2002 may include one or more components of the network node described above in connection with FIG. 1, such as a radio, one or more RF chains, one or more transceivers, or one or more modems, each of which may in turn be coupled with one or more antennas of the network node.

The transmission component 2004 may transmit communications, such as reference signals, control information, or data communications, to the apparatus 2008. In some aspects, the communication manager 2006 may generate communications and may transmit the generated communications to the transmission component 2004 for transmission to the apparatus 2008. In some aspects, the transmission component 2004 may perform signal processing on the generated communications, and may transmit the processed signals to the apparatus 2008 in a similar manner as described above in connection with FIG. 1. In some aspects, the transmission component 2004 may include one or more components of the network node described above in connection with FIG. 1, such as a radio, one or more RF chains, one or more transceivers, or one or more modems, each of which may in turn be coupled with one or more antennas of the network node. In some aspects, the transmission component 2004 may be co-located with the reception component 2002.

The communication manager 2006 may transmit or may cause the transmission component 2004 to transmit, to a UE, configuration information configuring a first quantity of L1 CLI measurement resources. The communication manager 2006 may receive or may cause the reception component 2002 to receive, from the UE, a measurement report for a second quantity of the L1 CLI measurement resources that indicates a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result. In some aspects, the communication manager 2006 may perform one or more operations described elsewhere herein as being performed by one or more components of the communication manager 2006.

In some aspects, the communication manager 2006 includes a set of components, such as a configuration component 2010. Alternatively, the set of components may be separate and distinct from the communication manager 2006. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 2004 or configuration component 2010 may transmit, to a UE, configuration information configuring a first quantity of L1 CLI measurement resources. The reception component 2002 may receive, from the UE, a measurement report for a second quantity of the L1 CLI measurement resources that indicates a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.

The quantity and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally or alternatively, a set of (one or more) components shown in FIG. 20 may perform one or more functions described as being performed by another set of components shown in FIG. 20.

FIG. 21 is a diagram of an example apparatus 2100 for wireless communication that supports measurement resource configuration and reporting. The apparatus 2100 may be a network node, or a network node may include the apparatus 2100. In some aspects, the apparatus 2100 includes a reception component 2102, a transmission component 2104, and a communication manager 2106, which may be in communication with one another (for example, via one or more buses). As shown, the apparatus 2100 may communicate with another apparatus 2108 (such as a UE 120, a network node 110, or another wireless communication device) using the reception component 2102 and the transmission component 2104. The communication manager 2106 may be included in, or implemented via, a processing system (for example, the processing system 145). In some aspects, the communication manager 2106 is the communication manager 155.

In some aspects, the apparatus 2100 may be configured to or operable to perform one or more operations described herein in connection with FIGS. 6A-6C. Additionally or alternatively, the apparatus 2100 may be configured to or operable to perform one or more processes described herein, such as process 1300 of FIG. 13.

The reception component 2102 may receive communications, such as reference signals, control information, or data communications, from the apparatus 2108. The reception component 2102 may provide received communications to one or more other components of the apparatus 2100, such as the communication manager 2106. In some aspects, the reception component 2102 may perform signal processing on the received communications, and may provide the processed signals to the one or more other components in a similar manner as described above in connection with FIG. 1. In some aspects, the reception component 2102 may include one or more components of the network node described above in connection with FIG. 1, such as a radio, one or more RF chains, one or more transceivers, or one or more modems, each of which may in turn be coupled with one or more antennas of the network node.

The transmission component 2104 may transmit communications, such as reference signals, control information, or data communications, to the apparatus 2108. In some aspects, the communication manager 2106 may generate communications and may transmit the generated communications to the transmission component 2104 for transmission to the apparatus 2108. In some aspects, the transmission component 2104 may perform signal processing on the generated communications, and may transmit the processed signals to the apparatus 2108 in a similar manner as described above in connection with FIG. 1. In some aspects, the transmission component 2104 may include one or more components of the network node described above in connection with FIG. 1, such as a radio, one or more RF chains, one or more transceivers, or one or more modems, each of which may in turn be coupled with one or more antennas of the network node. In some aspects, the transmission component 2104 may be co-located with the reception component 2102.

The communication manager 2106 may transmit or may cause the transmission component 2104 to transmit, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The communication manager 2106 may receive or may cause the reception component 2102 to receive, from the UE, the measurement report in accordance with the configuration information. In some aspects, the communication manager 2106 may perform one or more operations described elsewhere herein as being performed by one or more components of the communication manager 2106.

In some aspects, the communication manager 2106 includes a set of components, such as a configuration component 2110. Alternatively, the set of components may be separate and distinct from the communication manager 2106. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 2104 may transmit, to a UE, configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report. The reception component 2102 may receive, from the UE, the measurement report in accordance with the configuration information.

The quantity and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally or alternatively, a set of (one or more) components shown in FIG. 21 may perform one or more functions described as being performed by another set of components shown in FIG. 21.

FIG. 22 is a diagram of an example apparatus 2200 for wireless communication that supports measurement resource configuration and reporting. The apparatus 2200 may be a network node, or a network node may include the apparatus 2200. In some aspects, the apparatus 2200 includes a reception component 2202, a transmission component 2204, and a communication manager 2206, which may be in communication with one another (for example, via one or more buses). As shown, the apparatus 2200 may communicate with another apparatus 2208 (such as a UE 120, a network node 110, or another wireless communication device) using the reception component 2202 and the transmission component 2204. The communication manager 2206 may be included in, or implemented via, a processing system (for example, the processing system 145). In some aspects, the communication manager 2206 is the communication manager 155.

In some aspects, the apparatus 2200 may be configured to or operable to perform one or more operations described herein in connection with FIGS. 6A-6C. Additionally or alternatively, the apparatus 2200 may be configured to or operable to perform one or more processes described herein, such as process 1400 of FIG. 14.

The reception component 2202 may receive communications, such as reference signals, control information, or data communications, from the apparatus 2208. The reception component 2202 may provide received communications to one or more other components of the apparatus 2200, such as the communication manager 2206. In some aspects, the reception component 2202 may perform signal processing on the received communications, and may provide the processed signals to the one or more other components in a similar manner as described above in connection with FIG. 1. In some aspects, the reception component 2202 may include one or more components of the network node described above in connection with FIG. 1, such as a radio, one or more RF chains, one or more transceivers, or one or more modems, each of which may in turn be coupled with one or more antennas of the network node.

The transmission component 2204 may transmit communications, such as reference signals, control information, or data communications, to the apparatus 2208. In some aspects, the communication manager 2206 may generate communications and may transmit the generated communications to the transmission component 2204 for transmission to the apparatus 2208. In some aspects, the transmission component 2204 may perform signal processing on the generated communications, and may transmit the processed signals to the apparatus 2208 in a similar manner as described above in connection with FIG. 1. In some aspects, the transmission component 2204 may include one or more components of the network node described above in connection with FIG. 1, such as a radio, one or more RF chains, one or more transceivers, or one or more modems, each of which may in turn be coupled with one or more antennas of the network node. In some aspects, the transmission component 2204 may be co-located with the reception component 2202.

The communication manager 2206 may transmit or may cause the transmission component 2204 to transmit, to a UE, configuration information configuring a periodic CLI measurement resource and a first QCL assumption for type D for the periodic CLI measurement resource. The communication manager 2206 may transmit or may cause the transmission component 2204 to transmit, to the UE, a MAC-CE updating the first QCL assumption to a second QCL assumption. The communication manager 2206 may receive or may cause the reception component 2202 to receive, from the UE, a measurement report in accordance with the configuration information and the second QCL assumption. In some aspects, the communication manager 2206 may perform one or more operations described elsewhere herein as being performed by one or more components of the communication manager 2206.

In some aspects, the communication manager 2206 includes a set of components, such as a configuration component 2210. Alternatively, the set of components may be separate and distinct from the communication manager 2206. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 2204 may transmit, to a UE, configuration information configuring a periodic CLI measurement resource and a first QCL assumption for type D for the periodic CLI measurement resource. The transmission component 2204 may transmit, to the UE, a MAC-CE updating the first QCL assumption to a second QCL assumption. The reception component 2202 may receive, from the UE, a measurement report in accordance with the configuration information and the second QCL assumption.

The quantity and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally or alternatively, a set of (one or more) components shown in FIG. 22 may perform one or more functions described as being performed by another set of components shown in FIG. 22.

The following provides an overview of some Aspects of the present disclosure:
Aspect 1: A method of wireless communication performed by a user equipment (UE), comprising: receiving configuration information configuring a first quantity of layer 1 (L1) cross-link interference (CLI) measurement resources; and transmitting a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.
Aspect 2: The method of Aspect 1, wherein the second quantity is less than or equal to the first quantity.
Aspect 3: The method of any of Aspects 1-2, wherein one of: the L1 CLI measurement resources are L1 sounding reference signal reference signal received power (L1-SRS-RSRP) resources and the measurement range is −140 decibel-milliwatts (dBm) to −44 dBm, or the L1 CLI measurement resources are L1 CLI received signal strength indicator (L1-CLI-RSSI) resources and the measurement range is −100 dBm to −25 dBm.
Aspect 4: The method of any of Aspects 1-3, wherein the measurement report indicates a second measurement result for a second CLI measurement resource, of the second quantity of CLI measurement resources, by indicating one of: a second codepoint that maps to an out-of-range value in an L1 CLI differential codebook in accordance with the second measurement result being larger than the largest value of the measurement range, or a third codepoint that maps to a value in the L1 CLI differential codebook corresponding to a difference between the largest value of the measurement range and the second measurement result.
Aspect 5: The method of Aspect 4, wherein the second codepoint that maps to the out-of-range value in the L1 CLI differential codebook is one of: a first-in-position codepoint in the L1 CLI differential codebook, a last-in-position codepoint in the L1 CLI differential codebook, or an out-of-range codepoint in the L1 CLI differential codebook.
Aspect 6: The method of any of Aspects 1-5, wherein the measurement report indicates: a second measurement result for a second CLI measurement resource, of the second quantity of CLI measurement resources, by indicating a second codepoint that maps to a first value in an L1 CLI differential codebook corresponding to a first difference between the largest value of the measurement range and the second measurement result, and a third measurement result for a third CLI measurement resource, of the second quantity of CLI measurement resources, by indicating a third codepoint that maps to a second value in the L1 CLI differential codebook corresponding to a second difference between the second measurement result and the third measurement result.
Aspect 7: The method of any of Aspects 1-6, wherein the configuration information configures at least one of a quantity of bits for a codepoint used to report measurement results in the measurement report, the measurement range, a codebook resolution used to report the measurement results in the measurement report, or one or more events that trigger the measurement report.
Aspect 8: The method of Aspect 7, wherein receiving the configuration information that configures the at least one of the quantity of bits for the codepoint, the measurement range, the codebook resolution, or the one or more events includes receiving the configuration information via at least one of: a measurement report configuration information element (IE), a measurement resource configuration IE, or dedicated radio resource control signaling for indicating the at least one of the quantity of bits for the codepoint, the codebook resolution, or the one or more events.
Aspect 9: The method of Aspect 7, further comprising: detecting that the configuration information omits one or more indications corresponding to one or more of the quantity of bits for the codepoint, the measurement range, the codebook resolution, or the one or more events, wherein transmitting the measurement report is in accordance with one or more of a default quantity of bits for the codepoint, a default measurement range, a default codebook resolution, or a default set of events in response to detecting that the configuration information omits the one or more indications.
Aspect 10: The method of any of Aspects 1-9, wherein the first quantity of L1 CLI measurement resources include at least one periodic CLI measurement resource having a first quasi co-location (QCL) assumption for type D, wherein the method further comprises: receiving a medium access control (MAC) control element (MAC-CE) updating the first QCL assumption to a second QCL assumption; measuring the at least one periodic CLI measurement resource in accordance with the second QCL assumption; and transmitting the measurement report in accordance with the second QCL assumption.
Aspect 11: The method of Aspect 10, wherein the at least one periodic CLI measurement resource is one of: a periodic sounding reference signal reference signal received power (SRS-RSRP) resource, or a periodic CLI received signal strength indicator (CLI-RSSI) resource.
Aspect 12: A method of wireless communication performed by a user equipment (UE), comprising: receiving configuration information configuring a first quantity of layer 1 (L1) cross-link interference (CLI) measurement resources; and transmitting a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.
Aspect 13: The method of Aspect 12, wherein the measurement report indicates the first measurement result by indicating one of: a largest value of a measurement range in an L1 CLI absolute codebook in accordance with the first measurement result being larger than the largest value of the measurement range, or a value within the measurement range in accordance with the first measurement result being less than or equal to the largest value of the measurement range.
Aspect 14: A method of wireless communication performed by a user equipment (UE), comprising: receiving configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report; and transmitting the measurement report in accordance with the configuration information.
Aspect 15: The method of Aspect 14, wherein the measurement report is one of: a layer 3 (L3) cross-link interference received signal strength indicator (L3-CLI-RSSI) report, or an L3 sounding reference signal reference signal received power (L3-SRS-RSRP) report.
Aspect 16: The method of any of Aspects 14-15, wherein the measurement report is one of: a layer 1 (L1) cross-link interference received signal strength indicator (L1-CLI-RSSI) report, an L1 sounding reference signal reference signal received power (L1-SRS-RSRP) report, an L1-RSRP report, or an L1 signal-to-inference-plus-noise ratio (L1-SINR) report.
Aspect 17: The method of any of Aspects 14-16, wherein receiving the configuration information includes receiving the configuration information via at least one of: a measurement report configuration information element (IE), a measurement resource configuration IE, or dedicated radio resource control signaling for indicating the at least one of the quantity of bits for the codepoint, the codebook resolution, or the one or more events.
Aspect 18: The method of any of Aspects 14-17, further comprising: detecting that the configuration information omits one or more indications corresponding to one or more of the quantity of bits for the codepoint, the measurement range, the codebook resolution, or the one or more events, wherein transmitting the measurement report is in accordance with one or more of a default quantity of bits for the codepoint, a default measurement range, a default codebook resolution, or a default set of events in response to detecting that the configuration information omits the one or more indications.
Aspect 19: A method of wireless communication performed by a user equipment (UE), comprising: receiving configuration information configuring a periodic cross-link interference (CLI) measurement resource and a first quasi co-location (QCL) assumption for type D for the periodic CLI measurement resource; receiving a medium access control (MAC) control element (MAC-CE) updating the first QCL assumption to a second QCL assumption; measuring the periodic CLI measurement resource in accordance with the second QCL assumption; and transmitting a measurement report in accordance with the configuration information and the second QCL assumption.
Aspect 20: The method of Aspect 19, wherein the periodic CLI measurement resource is one of: a periodic sounding reference signal reference signal received power (SRS-RSRP) resource, or a periodic CLI received signal strength indicator (CLI-RSSI) resource.
Aspect 21: A method of wireless communication performed by a network node, comprising: transmitting, to a user equipment (UE), configuration information configuring a first quantity of layer 1 (L1) cross-link interference (CLI) measurement resources; and receiving, from the UE, a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.
Aspect 22: The method of Aspect 21, wherein the second quantity is less than or equal to the first quantity.
Aspect 23: The method of any of Aspects 21-22, wherein one of: the L1 CLI measurement resources are L1 sounding reference signal reference signal received power (L1-SRS-RSRP) resources and the measurement range is −140 decibel-milliwatts (dBm) to −44 dBm, or the L1 CLI measurement resources are L1 CLI received signal strength indicator (L1-CLI-RSSI) resources and the measurement range is −100 dBm to −25 dBm.
Aspect 24: The method of any of Aspects 21-23, wherein the measurement report indicates a second measurement result for a second CLI measurement resource, of the second quantity of CLI measurement resources, by indicating one of: a second codepoint that maps to an out-of-range value in an L1 CLI differential codebook in accordance with the second measurement result being larger than the largest value of the measurement range, or a third codepoint that maps to a value in the L1 CLI differential codebook corresponding to a difference between the largest value of the measurement range and the second measurement result.
Aspect 25: The method of Aspect 24, wherein the second codepoint that maps to the out-of-range value in the L1 CLI differential codebook is one of: a first-in-position codepoint in the L1 CLI differential codebook, a last-in-position codepoint in the L1 CLI differential codebook, or an out-of-range codepoint in the L1 CLI differential codebook.
Aspect 26: The method of any of Aspects 21-25, wherein the measurement report indicates: a second measurement result for a second CLI measurement resource, of the second quantity of CLI measurement resources, by indicating a second codepoint that maps to a first value in an L1 CLI differential codebook corresponding to a first difference between the largest value of the measurement range and the second measurement result, and a third measurement result for a third CLI measurement resource, of the second quantity of CLI measurement resources, by indicating a third codepoint that maps to a second value in the L1 CLI differential codebook corresponding to a second difference between the second measurement result and the third measurement result.
Aspect 27: The method of any of Aspects 21-26, wherein the configuration information configures at least one of a quantity of bits for a codepoint used to report measurement results in the measurement report, the measurement range, a codebook resolution used to report the measurement results in the measurement report, or one or more events that trigger the measurement report.
Aspect 28: The method of Aspect 27, wherein transmitting the configuration information that configures the at least one of the quantity of bits for the codepoint, the measurement range, the codebook resolution, or the one or more events includes transmitting the configuration information via at least one of: a measurement report configuration information element (IE), a measurement resource configuration IE, or dedicated radio resource control signaling for indicating the at least one of the quantity of bits for the codepoint, the codebook resolution, or the one or more events.
Aspect 29: The method of Aspect 27, wherein the configuration information omits one or more indications corresponding to one or more of the quantity of bits for the codepoint, the measurement range, the codebook resolution, or the one or more events, and wherein the measurement report is in accordance with one or more of a default quantity of bits for the codepoint, a default measurement range, a default codebook resolution, or a default set of events in response to the configuration information omitting the one or more indications.
Aspect 30: The method of any of Aspects 21-29, wherein the first quantity of L1 CLI measurement resources include at least one periodic CLI measurement resource having a first quasi co-location (QCL) assumption for type D, wherein the method further comprises transmitting, to the UE, a medium access control (MAC) control element (MAC-CE) updating the first QCL assumption to a second QCL assumption, and wherein the measurement report is in accordance with the second QCL assumption.
Aspect 31: The method of Aspect 30, wherein the at least one periodic CLI measurement resource is one of: a periodic sounding reference signal reference signal received power (SRS-RSRP) resource, or a periodic CLI received signal strength indicator (CLI-RSSI) resource.
Aspect 32: A method of wireless communication performed by a network node, comprising: transmitting, to a user equipment (UE), configuration information configuring a first quantity of layer 1 (L1) cross-link interference (CLI) measurement resources; and receiving, from the UE, a measurement report for a second quantity of the L1 CLI measurement resources that indicates: a first measurement result for a first CLI measurement resource, of the second quantity of CLI measurement resources, a second measurement result for a second CLI measurement resource, of the second quantity of CLI measurement resources, by indicating a first difference between the first measurement result and the second measurement result, and a third measurement result for a third CLI measurement resource, of the second quantity of CLI measurement resources, by indicating a second difference between the second measurement result and the third measurement result.
Aspect 33: The method of Aspect 32, wherein the measurement report indicates the first measurement result by indicating one of: a largest value of a measurement range in an L1 CLI absolute codebook in accordance with the first measurement result being larger than the largest value of the measurement range, or a value within the measurement range in accordance with the first measurement result being less than or equal to the largest value of the measurement range.
Aspect 34: A method of wireless communication performed by a network node, comprising: transmitting, to a user equipment (UE), configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report; and receiving, from the UE, the measurement report in accordance with the configuration information.
Aspect 35: The method of Aspect 34, wherein the measurement report is one of: a layer 3 (L3) cross-link interference received signal strength indicator (L3-CLI-RSSI) report, or an L3 sounding reference signal reference signal received power (L3-SRS-RSRP) report.
Aspect 36: The method of any of Aspects 34-35, wherein the measurement report is one of: a layer 1 (L1) cross-link interference received signal strength indicator (L1-CLI-RSSI) report, an L1 sounding reference signal reference signal received power (L1-SRS-RSRP) report, an L1-RSRP report, or an L1 signal to inference plus noise ratio (L1-SINR) report.
Aspect 37: The method of any of Aspects 34-36, wherein transmitting the configuration information includes transmitting the configuration information via at least one of: a measurement report configuration information element (IE), a measurement resource configuration IE, or dedicated radio resource control signaling for indicating the at least one of the quantity of bits for the codepoint, the codebook resolution, or the one or more events.
Aspect 38: The method of any of Aspects 34-37, wherein the configuration information omits one or more indications corresponding to one or more of the quantity of bits for the codepoint, the measurement range, the codebook resolution, or the one or more events, and wherein the measurement report is in accordance with one or more of a default quantity of bits for the codepoint, a default measurement range, a default codebook resolution, or a default set of events in response to the configuration information omitting the one or more indications.
Aspect 39: A method of wireless communication performed by a network node, comprising: transmitting, to a user equipment (UE), configuration information configuring a periodic cross-link interference (CLI) measurement resource and a first quasi co-location (QCL) assumption for type D for the periodic CLI measurement resource; transmitting, to the UE, a medium access control (MAC) control element (MAC-CE) updating the first QCL assumption to a second QCL assumption; and receiving, from the UE, a measurement report in accordance with the configuration information and the second QCL assumption.
Aspect 40: The method of Aspect 39, wherein the periodic CLI measurement resource is one of: a periodic sounding reference signal reference signal received power (SRS-RSRP) resource, or a periodic CLI received signal strength indicator (CLI-RSSI) resource.
Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.
Aspect 42: An apparatus for wireless communication at a device, the apparatus comprising one or more memories and one or more processors coupled to the one or more memories, the one or more processors configured to cause the device to perform the method of one or more of Aspects 1-40.
Aspect 43: An apparatus for wireless communication, the apparatus comprising at least one means for performing the method of one or more of Aspects 1-40.
Aspect 44: A non-transitory computer-readable medium storing code for wireless communication, the code comprising instructions executable by one or more processors to perform the method of one or more of Aspects 1-40.
Aspect 45: A non-transitory computer-readable medium storing a set of instructions for wireless communication, the set of instructions comprising one or more instructions that, when executed by one or more processors of a device, cause the device to perform the method of one or more of Aspects 1-40.
Aspect 46: A device for wireless communication, the device comprising a processing system that includes one or more processors and one or more memories coupled with the one or more processors, the processing system configured to cause the device to perform the method of one or more of Aspects 1-40.
Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.
Aspect 48: A device comprising a processing system that includes one or more processors and one or more code-storing memories coupled with the one or more processors, the processing system configured to cause the device to perform the method of one or more of Aspects 1-40.
Aspect 49: A device comprising a processing system that includes processor circuitry and code-storing memory circuitry, the processing system configured to cause the device to perform the method of one or more of Aspects 1-40.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive configuration information configuring a first quantity of layer 1 (L1) cross-link interference (CLI) measurement resources; and
transmit a measurement report for a second quantity of the L1 CLI measurement resources that indicates a first measurement result for a first CLI measurement resource, of the second quantity of CLI measurement resources, by indicating a first codepoint that maps to a largest value of a measurement range in an L1 CLI absolute codebook in accordance with the first measurement result being larger than the largest value of the measurement range.

2. The UE of claim 1, wherein the second quantity is less than or equal to the first quantity.

3. The UE of claim 1, wherein one of:
the L1 CLI measurement resources are L1 sounding reference signal reference signal received power (L1-SRS-RSRP) resources and the measurement range is −140 decibel-milliwatts (dBm) to −44 dBm, or
the L1 CLI measurement resources are L1 CLI received signal strength indicator (L1-CLI-RSSI) resources and the measurement range is −100 dBm to −25 dBm.

4. The UE of claim 1, wherein the measurement report indicates a second measurement result for a second CLI measurement resource, of the second quantity of CLI measurement resources, by indicating one of:
a second codepoint that maps to an out-of-range value in an L1 CLI differential codebook in accordance with the second measurement result being larger than the largest value of the measurement range, or
a third codepoint that maps to a value in the L1 CLI differential codebook corresponding to a difference between the largest value of the measurement range and the second measurement result.

5. The UE of claim 4, wherein the second codepoint that maps to the out-of-range value in the L1 CLI differential codebook is one of:
a first-in-position codepoint in the L1 CLI differential codebook,
a last-in-position codepoint in the L1 CLI differential codebook, or
an out-of-range codepoint in the L1 CLI differential codebook.

6. The UE of claim 1, wherein the measurement report indicates:
a second measurement result for a second CLI measurement resource, of the second quantity of CLI measurement resources, by indicating a second codepoint that maps to a first value in an L1 CLI differential codebook corresponding to a first difference between the largest value of the measurement range and the second measurement result, and
a third measurement result for a third CLI measurement resource, of the second quantity of CLI measurement resources, by indicating a third codepoint that maps to a second value in the L1 CLI differential codebook corresponding to a second difference between the second measurement result and the third measurement result.

7. The UE of claim 1, wherein the configuration information configures at least one of a quantity of bits for a codepoint used to report measurement results in the measurement report, the measurement range, a codebook resolution used to report the measurement results in the measurement report, or one or more events that trigger the measurement report.

8. The UE of claim 7, wherein the processing system, to cause the UE to receive the configuration information that configures the at least one of the quantity of bits for the codepoint, the measurement range, the codebook resolution, or the one or more events, is configured to cause the UE to receive the configuration information via at least one of:
a measurement report configuration information element (IE),
a measurement resource configuration IE, or
dedicated radio resource control signaling for indicating the at least one of the quantity of bits for the codepoint, the codebook resolution, or the one or more events.

9. The UE of claim 7, wherein the processing system is configured to cause the UE to detect that the configuration information omits one or more indications corresponding to one or more of the quantity of bits for the codepoint, the measurement range, the codebook resolution, or the one or more events, and
wherein, to cause the UE to transmit the measurement report, the processing system is configured to cause the UE to transmit the measurement report in accordance with one or more of a default quantity of bits for the codepoint, a default measurement range, a default codebook resolution, or a default set of events in response to detecting that the configuration information omits the one or more indications.

10. The UE of claim 1, wherein the first quantity of L1 CLI measurement resources include at least one periodic CLI measurement resource having a first quasi co-location (QCL) assumption for type D,
wherein the processing system is further configured to cause the UE to:
receive a medium access control (MAC) control element (MAC-CE) updating the first QCL assumption to a second QCL assumption;
measure the at least one periodic CLI measurement resource in accordance with the second QCL assumption; and
transmit the measurement report in accordance with the second QCL assumption.

11. The UE of claim 10, wherein the at least one periodic CLI measurement resource is one of:
a periodic sounding reference signal reference signal received power (SRS-RSRP) resource, or
a periodic CLI received signal strength indicator (CLI-RSSI) resource.

12. A user equipment (UE), comprising:
a processing system that includes one or more processors and one or more code-storing memories coupled with the one or more processors, the processing system configured to cause the UE to:
receive configuration information configuring a first quantity of layer 1 (L1) cross-link interference (CLI) measurement resources; and
transmit a measurement report for a second quantity of the L1 CLI measurement resources that indicates:
a first measurement result for a first CLI measurement resource, of the second quantity of CLI measurement resources,
a second measurement result for a second CLI measurement resource, of the second quantity of CLI measurement resources, by indicating a first difference between the first measurement result and the second measurement result, and
a third measurement result for a third CLI measurement resource, of the second quantity of CLI measurement resources, by indicating a second difference between the second measurement result and the third measurement result.

13. The UE of claim 12, wherein the measurement report indicates the first measurement result by indicating one of:
a largest value of a measurement range in an L1 CLI absolute codebook in accordance with the first measurement result being larger than the largest value of the measurement range, or
a value within the measurement range in accordance with the first measurement result being less than or equal to the largest value of the measurement range.

14. A user equipment (UE), comprising:
a processing system that includes one or more processors and one or more code-storing memories coupled with the one or more processors, the processing system configured to cause the UE to:
receive configuration information configuring at least one of a quantity of bits for a codepoint used to report measurement results in a measurement report, a measurement range used to report the measurement results in the measurement report, a codebook resolution used to report the measurement results in the measurement report, or one or more events that trigger the measurement report; and
transmit the measurement report in accordance with the configuration information.

15. The UE of claim 14, wherein the measurement report is one of:
a layer 3 (L3) cross-link interference received signal strength indicator (L3-CLI-RSSI) report, or an L3 sounding reference signal reference signal received power (L3-SRS-RSRP) report.

16. The UE of claim 14, wherein the measurement report is one of:
a layer 1 (L1) cross-link interference received signal strength indicator (L1-CLI-RSSI) report,
an L1 sounding reference signal reference signal received power (L1-SRS-RSRP) report,
an L1-RSRP report, or
an L1 signal-to-inference-plus-noise ratio (L1-SINR) report.

17. The UE of claim 14, wherein the processing system, to cause the UE to receive the configuration information, is configured to cause the UE to receive the configuration information via at least one of:
a measurement report configuration information element (IE),
a measurement resource configuration IE, or
dedicated radio resource control signaling for indicating the at least one of the quantity of bits for the codepoint, the codebook resolution, or the one or more events.

18. The UE of claim 14, wherein the processing system is configured to cause the UE to detect that the configuration information omits one or more indications corresponding to one or more of the quantity of bits for the codepoint, the measurement range, the codebook resolution, or the one or more events, and
wherein, to cause the UE to transmit the measurement report, the processing system is configured to cause the UE to transmit the measurement report in accordance with one or more of a default quantity of bits for the codepoint, a default measurement range, a default codebook resolution, or a default set of events in response to detecting that the configuration information omits the one or more indications.

19. A user equipment (UE), comprising:
a processing system that includes one or more processors and one or more code-storing memories coupled with the one or more processors, the processing system configured to cause the UE to:
receive configuration information configuring a periodic cross-link interference (CLI) measurement resource and a first quasi co-location (QCL) assumption for type D for the periodic CLI measurement resource;
receive a medium access control (MAC) control element (MAC-CE) updating the first QCL assumption to a second QCL assumption;
measure the periodic CLI measurement resource in accordance with the second QCL assumption; and
transmit a measurement report in accordance with the configuration information and the second QCL assumption.

20. The UE of claim 19, wherein the periodic CLI measurement resource is one of:
a periodic sounding reference signal reference signal received power (SRS-RSRP) resource, or
a periodic CLI received signal strength indicator (CLI-RSSI) resource.
